(19) United States
(12) Patent Application Publication
(10) Pub. No.: US 2011/0249146 A1
(43) Pub. Date: Oct. 13, 2011

(54) Imaging device, display control method and program

(75) Inventor: Yoshihiro Ishida, Tokyo (JP)

(73) Assignee: Sony Corporation, Tokyo (JP)

(21) Appl. No.: 13/065,838

(22) Filed: Mar. 31, 2011

(30) Foreign Application Priority Data
Apr. 9, 2010 (JP) P2010-090118

(51) Int. Cl. H04N 5/228; H04N 5/76

(52) U.S. Cl. 348/231.99; 348/222.1; 348/E05.031

(57) ABSTRACT

An imaging device includes an image unit that captures a subject and generates a plurality of consecutive captured images in time series, a synthesis unit that performs synthesis using at least a part of each of the plurality of generated captured images and generates a plurality of synthesized images having an order relationship based on a predetermined rule, and a control unit which performs control for displaying information about the progress of the generation of the synthesized images by the synthesis unit on a display unit as progress information, after the process of generating the plurality of captured images by the imaging unit is finished.

### BACKGROUND OF THE INVENTION

1. Field of the Invention

The present invention relates to an imaging device and, more particularly, to an imaging device for displaying an image, a display control method, and a program for executing the method on a computer.

2. Description of the Related Art

Recently, imaging devices for capturing a subject, such as a person or an animal, so as to generate image data and recording the image data as image content, such as a digital camera or a digital video camera (for example, a camcorder), have come into wide use. An imaging device for displaying an image to be recorded on a display unit when an imaging action is finished so as to confirm image content is being proposed (a so-called review display).

An imaging device for generating a plurality of images by a series of imaging actions and recording the plurality of generated images in association with each other exists. For example, there is an imaging device for recording a plurality of images generated by consecutive photographing in association with each other. In the case where the plurality of recorded images is reproduced, for example, a list of representative images set in a consecutive photographing unit is displayed and a desired representative image is selected from the list of representative images. A plurality of images corresponding to the selected representative image may be displayed.

For example, an image display device for adjusting the display size of each consecutive image according to the number of consecutive images to be displayed as an image list and displaying a list of a plurality of consecutive images by the adjusted display size is proposed (for example, see Japanese Unexamined Patent Application Publication No. 2009-296380 (FIG. 6)).

### SUMMARY OF THE INVENTION

According to the above-described related art, in order to display the list of the plurality of consecutive images by the adjusted display size, it is possible to simultaneously display the list of consecutive images.

Here, a case where an imaging action is performed using an imaging device for recording a plurality of images generated by a series of imaging action in association with each other is considered. In the case of performing the series of imaging actions using this imaging device, if the plurality of images generated by the imaging actions is confirmed after the imaging actions are finished, at least a part of the images is review-displayed.

For example, in the case where photographing is performed at a tourist spot of a travel destination, since each person may move, photographing timing becomes important. To this end, even after a series of imaging actions is finished, it is important to rapidly confirm the composition and desired subject. For example, as described above, after the series of imaging actions is finished, at least a part of the plurality of images generated by the imaging actions is review-displayed.

Although the plurality of images generated by the imaging actions may be confirmed by performing display after the series of imaging actions is finished, if the number of images to be generated is large, the processing time thereof is relatively long. If the progress situation is not checked when the processing time associated with the generation of the plurality of images increases, the preparation of the next imaging action may not be adequately performed.

It is desirable to be able to easily check the progress situation of image generation when a plurality of synthesized images is generated by a series of imaging actions.

According to an embodiment of the present invention, there are provided an imaging device including: an image unit that captures a subject and generates a plurality of consecutive captured images in time series; a synthesis unit that performs synthesis using at least a part of each of the plurality of generated captured images and generates a plurality of synthesized images having an order relationship based on a predetermined rule; and a control unit which performs control for displaying information about the progress of the generation of the synthesized images by the synthesis unit on a display unit as progress information, after the process of generating the plurality of captured images by the imaging unit is finished, a display control method thereof, a program for, on a computer, executing the method. Accordingly, a subject is captured and a plurality of consecutive captured images in time series is generated, synthesis is performed using at least a part of each of the plurality of generated captured images and a plurality of synthesized images having an order relationship based on a predetermined rule is generated, and information about the progress of the generation of the synthesized images is displayed as progress information, after the process of generating the plurality of captured images is finished.

The synthesis unit may generate multi-viewpoint images as the plurality of synthesized images, and the control unit may perform control for displaying a central image or an image near the central image of the multi-viewpoint images as a representative image on the display unit along with the progress information, immediately after the process of generating the plurality of captured images by the imaging unit is finished. Accordingly, immediately after the process of generating the plurality of captured images is finished, the central image or the image near the central image of the multi-viewpoint images is displayed as the representative image along with the progress information.

The control unit may perform control for displaying the progress information based on the number of synthesized images generated by the synthesis unit to the total number of the plurality of synthesized images as an object to be generated by the synthesis unit. Accordingly, the progress information is displayed based on the number of synthesized images generated by the synthesis unit to the total number of the plurality of synthesized images as the object to be generated by the synthesis unit.

The control unit may perform control for displaying a progress bar indicating to what extent the synthesized images have been generated by the synthesis unit using a bar graph as the progress information. Accordingly, the progress bar indicating to what extent the synthesized images have been generated by the synthesis unit using a bar graph is displayed.

The control unit may perform control for displaying the progress information on the display unit immediately after the process of generating the plurality of captured images by the imaging unit is finished. Accordingly, the progress information is displayed immediately after the process of generating the plurality of captured images by the imaging unit is finished.

The control unit may perform control for sequentially displaying at least a part of the generated synthesized images on the display unit along with the progress information. Accordingly, at least a part of the generated synthesized images is sequentially displayed along with the progress information.

The control unit may perform control for initially displaying a synthesized image which is arranged in a predetermined order of the generated synthesized images on the display unit as a representative image. Accordingly, a synthesized image which is arranged in the predetermined order of the generated synthesized images is initially displayed as a representative image.

The imaging device may further include a recording control unit that associates representative image information indicating the representative image and the order relationship with the plurality of generated synthesized images and records the plurality of generated synthesized images on a recording medium. Accordingly, representative image information indicating the representative image and the order relationship are associated with the plurality of generated synthesized images and the plurality of synthesized images is recorded on a recording medium.

The recording control unit may record the plurality of generated synthesized images associated with the representative image information and the order relationship on the recording medium as an MP file. Accordingly, the plurality of synthesized images associated with the representative image information and the order relationship is recorded on the recording medium as an MP file.

According to the embodiment of the present invention, it is possible to easily identify the progress situation of the generation of the plurality of synthesized images by a series of imaging actions.

### BRIEF DESCRIPTION OF THE DRAWINGS

FIG. 1 is a block diagram showing an internal configuration example of an imaging device according to a first embodiment of the present invention;

FIGS. 2A to 2C are schematic diagrams showing an image file stored in a removable medium according to the first embodiment of the present invention;

FIGS. 3A and 3B are diagrams showing a display example of a setting screen for setting a photographing mode of a multi-viewpoint image by the imaging device according to the first embodiment of the present invention;

FIGS. 4A and 4B are schematic diagrams showing an imaging action example and a notification example of a progress situation of the imaging action when a multi-viewpoint image is generated using the imaging device according to the first embodiment of the present invention;

FIGS. 5A and 5B are schematic diagrams showing an imaging action example and an example of the flow of the plurality of captured images generated by the imaging action when a multi-viewpoint image is generated using the imaging device according to the first embodiment of the present invention;

FIGS. 6A and 6B are schematic diagrams showing a generation method when a multi-viewpoint image is generated by the imaging device according to the first embodiment of the present invention;

FIG. 7 is a schematic diagram showing a generation method when a multi-viewpoint image is generated by the imaging device according to the first embodiment of the present invention;

FIGS. 8A to 8C are schematic diagrams showing a generation method when a multi-viewpoint image is generated by the imaging device according to the first embodiment of the present invention;

FIG. 9 is a schematic diagram showing the flow until the multi-viewpoint image generated by the imaging device according to the first embodiment of the present invention is recorded in the removable medium;

FIG. 10 is a schematic diagram showing the flow until a representative image of the multi-viewpoint images generated by the imaging device according to the first embodiment of the present invention is displayed;

FIG. 11 is a block diagram showing a functional configuration example of the imaging device according to the first embodiment of the present invention;

FIGS. 12A to 12C are diagrams showing a display example of a representative image displayed on a display unit according to the first embodiment of the present invention;

FIGS. 13A to 13C are diagrams showing a display transition example of multi-viewpoint images displayed on the display unit according to the first embodiment of the present invention;

FIGS. 14A to 14C are diagrams showing a display transition example of multi-viewpoint images displayed on the display unit according to the first embodiment of the present invention;

FIGS. 15A to 15C are diagrams showing a display transition example of multi-viewpoint images displayed on the display unit according to the first embodiment of the present invention;

FIGS. 16A to 16C are diagrams showing a display transition example of multi-viewpoint images displayed on the display unit according to the first embodiment of the present invention;

FIGS. 17A to 17C are diagrams showing progress situation notification information of a synthesis process of the multi-viewpoint images displayed on the display unit according to the first embodiment of the present invention;

FIGS. 18A and 18B are diagrams showing a display transition example of a progress situation notification screen displayed on the display unit according to the first embodiment of the present invention;

FIGS. 19A to 19D are diagrams showing a display transition example of a progress situation notification screen displayed on the display unit according to the first embodiment of the present invention;

FIGS. 20A to 20D are diagrams showing a display transition example of a progress situation notification screen displayed on the display unit according to the first embodiment of the present invention;

FIGS. 21A to 21D are diagrams showing a display transition example of a progress situation notification screen displayed on the display unit according to the first embodiment of the present invention;

FIG. 22 is a flowchart illustrating an example of a procedure of a multi-viewpoint image recording process by the imaging device according to the first embodiment of the present invention;

FIG. 23 is a flowchart illustrating an example of a captured image recording process of the procedure of the multi-viewpoint image recording process by the imaging device according to the first embodiment of the present invention;

FIG. 24 is a flowchart illustrating an example of a representative image decision process of the procedure of the multi-viewpoint image recording process by the imaging device according to the first embodiment of the present invention;

FIG. 25 is a flowchart illustrating an example of a progress bar computation process of the procedure of the multi-viewpoint image recording process by the imaging device according to the first embodiment of the present invention;

FIG. 26 is a flowchart illustrating an example of a representative image generation process of the procedure of the multi-viewpoint image recording process by the imaging device according to the first embodiment of the present invention;

FIG. 27 is a flowchart illustrating an example of a viewpoint j image generation process of the procedure of the multi-viewpoint image recording process by the imaging device according to the first embodiment of the present invention;

FIGS. 28A and 28B are diagrams showing an example of an appearance configuration example of an imaging device according to a second embodiment of the present invention and an example of the attitude thereof when the imaging device is used;

FIGS. 29A and 29B are schematic diagrams showing a relationship between a plurality of multi-viewpoint images generated using the imaging device according to the second embodiment of the present invention and an inclination angle of the imaging device when the images are review-displayed;

FIGS. 30A and 30B are diagrams showing a display transition example of an image displayed on an input/output panel according to the second embodiment of the present invention;

FIGS. 31A and 31B are diagrams showing a display transition example of an image displayed on the input/output panel according to the second embodiment of the present invention;

FIG. 32 is a flowchart illustrating an example of a procedure of a multi-viewpoint image recording process by the imaging device according to the second embodiment of the present invention;

FIG. 33 is a flowchart illustrating an example of a procedure of a multi-viewpoint image recording process by the imaging device according to the second embodiment of the present invention;

FIG. 34 is a flowchart illustrating an example of a procedure of a multi-viewpoint image recording process by the imaging device according to the second embodiment of the present invention; and

FIG. 35 is a flowchart illustrating an example of a procedure of a multi-viewpoint image recording process by the imaging device according to the second embodiment of the present invention.

### DESCRIPTION OF THE PREFERRED EMBODIMENTS

Hereinafter, modes (hereinafter, referred to as embodiments) for carrying out the present invention will be described. The description is given in the following order.

1. First Embodiment (display control: Example of displaying representative image and progress situation notification information after imaging actions of multi-viewpoint images are finished)

2. Second Embodiment (display control: Example of sequentially review-displaying representative image candidates of multi-viewpoint images according to change in device attitude and deciding on representative image)

### 1. First Embodiment

### Configuration Example of Imaging Device

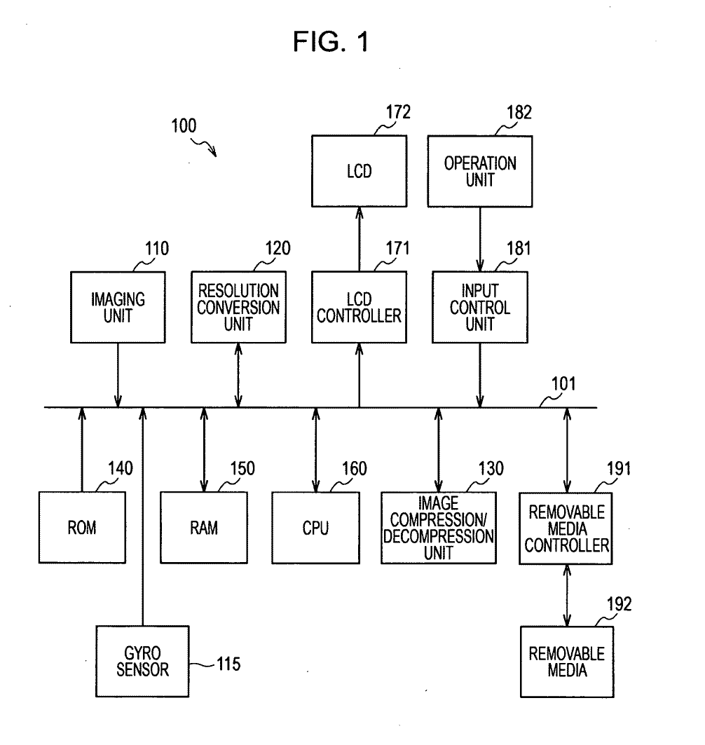

FIG. 1 is a block diagram showing an internal configuration example of an imaging device 100 according to a first embodiment of the present invention. The imaging device 100 includes an imaging unit 110, a gyro sensor 115, a resolution conversion unit 120, and an image compression/decompression unit 130. The imaging device 100 includes a Read Only Memory (ROM) 140, a Random Access Memory (RAM) 150, and a Central Processing Unit (CPU) 160. The imaging device 100 includes a Liquid Crystal Display (LCD) controller 171, an LCD 172, an input control unit 181, an operation unit 182, a removable media controller 191, and a removable medium 192. Exchange performed between the units configuring the imaging device 100 is performed through a bus 101. The imaging device 100 may be, for example, realized by a digital camera for capturing a subject, generating plural pieces of image data (captured images), and performing various image processes with respect to the plural pieces of image data.

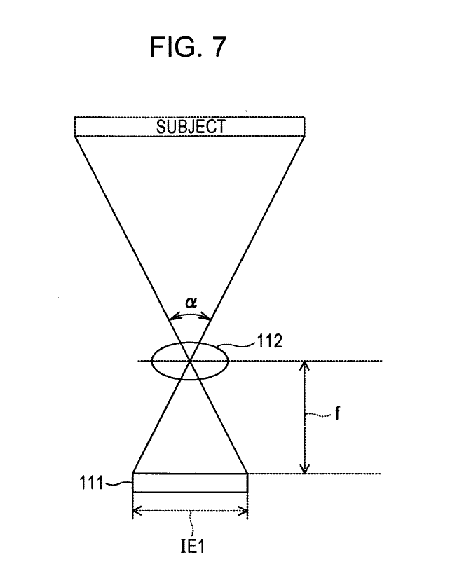

The imaging unit 110 converts incident light from the subject, generates the image data (captured image), and supplies the generated image data to the RAM 150, based on the control of the CPU 160. Specifically, the imaging unit 110 includes an optical unit 112 (shown in FIG. 7), an imaging element 111 (shown in FIG. 7) and a signal processing unit (not shown). The optical unit includes a plurality of lenses (a zoom lens, a focus lens, and the like) for focusing the light from the subject and supplies the light from the subject incident through the lenses and an iris to the imaging element. An optical image of the subject incident through the optical unit is formed on an imaging surface of the imaging element and is captured by the imaging element in this state, and the captured image is output to the signal processing unit. The image processing unit performs signal processing with respect to the captured signal so as to generate image data, and the generated image data is sequentially supplied to the RAM 150 so as to be temporarily held. As the imaging element, for example, a Charge Coupled Device (CCD) sensor, a Complementary Metal Oxide Semiconductor (CMOS) sensor or the like may be used.

The gyro sensor 115 detects an angular velocity of the imaging device 100 and outputs the detected angular velocity to the CPU 160. Acceleration, motion, inclination and the like of the imaging device 100 may be detected using a sensor (for example, an acceleration sensor) other than the gyro sensor, and the CPU 160 may detect a change in the attitude of the imaging device 100 based on the detected result.

The resolution conversion unit 120 converts resolution of a variety of input image data into resolution to suit image processes, based on a control signal from the CPU 160.

The image compression/decompression unit 130 compresses or decompresses the variety of input image data according to image processes, based on a control signal from the CPU 160. The image compression/decompression unit 130 compresses or decompresses, for example, the variety of input image data to image data of a Joint Photographic Experts Group (JPEG) format.

The ROM 140 is a read only memory and stores various control programs and the like.

The RAM 150 is a memory used in the main memory (main storage device) of the CPU 160, includes a working region and the like for a program executed in the CPU 160, and temporarily holds a program or data necessary to perform various processes by the CPU 160. The RAM 150 includes an image storage region for various image processes.

The CPU 160 controls the units of the imaging device 100 based on various control programs stored in the ROM 140. The CPU 160 controls the units of the imaging device 100 based on an operation input or the like received by the operation unit 182.

The LCD controller 171 displays a variety of image data on the LCD 172 based on a control signal from the CPU 160.

The LCD 172 is a display unit for displaying an image corresponding to the variety of image data supplied from the LCD controller 171. The LCD 172 sequentially displays, for example, the captured images corresponding to the image data generated by the imaging unit 110 (a so-called monitoring display). The LCD 172 displays, for example, an image corresponding to an image file stored in the removable medium 192. Instead of the LCD 172, for example, a display panel such as an organic Electro Luminescence (EL) panel may be used. As the display panel, a touch panel for performing an operation input by touching or approaching a user's finger to a display surface may be used.

The input control unit 181 performs control of the operation input received by the operation unit 182 based on an instruction from the CPU 160.

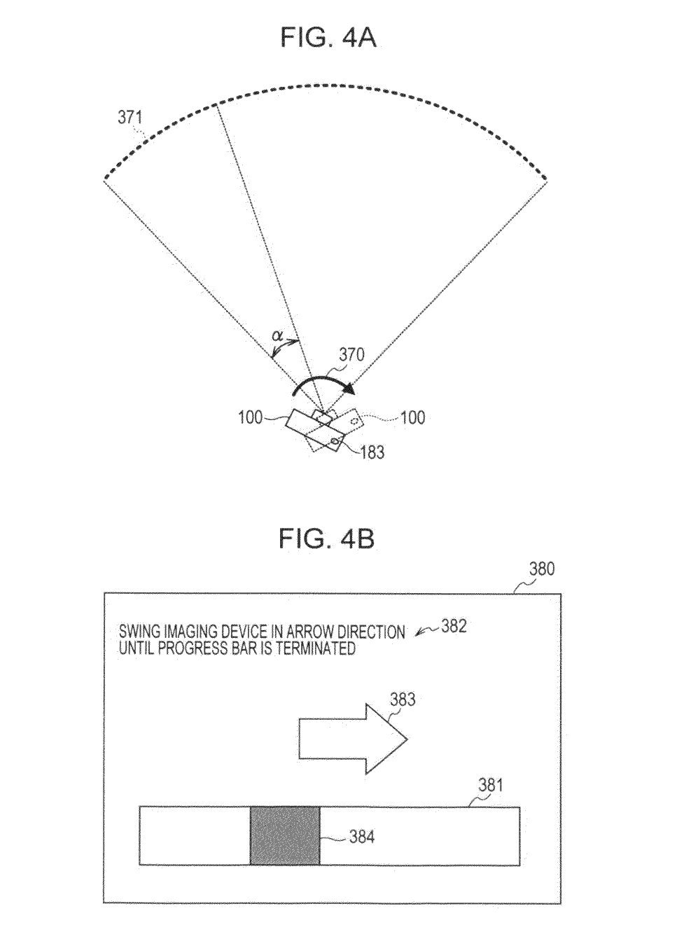

The operation unit 182 receives the operation input manipulated by the user and outputs a signal corresponding to the received operation input to the CPU 160. For example, in a multi-viewpoint photographing mode for recording a multi-viewpoint image, an operation member such as a shutter button 183 (shown in FIG. 4A) for instructing an imaging action start and an imaging action end of captured images for generating multi-viewpoint images is included in the imaging device 100. The multi-viewpoint images generated in the first embodiment of the present invention are multi-viewpoint stereoscopic images (for example, panoramic stereoscopic images). The operation unit 182 and the LCD 172 may be integrally configured using a touch panel.

The removable media controller 191 is connected to the removable medium 192, and reads and records data in the removable medium 192 based on a control signal from the CPU 160. For example, the removable media controller 191 records a variety of image data such as the image data generated by the imaging unit 110 in the removable medium 192 as an image file (image content). The removable media controller 191 reads content such as the image file from the removable medium 192 and outputs the content to the RAM 150 or the like through the bus 101.

The removable medium 192 is a recording device (recording medium) for recording the image data supplied from the removable media controller 191. In the removable medium 192, for example, a variety of data such as JPEG format image data is recorded. As the removable medium 192, for example, a tape (for example, a magnetic tape) or an optical disc (for example, a recordable Digital Versatile Disc (DVD)) may be used. As the removable medium 192, for example, a magnetic disk (for example, a hard disk), a semiconductor memory (for example, a memory card) or a magneto-optical disc (for example, a Mini Disc (MD)) may be used.

### Configuration Example of Image File

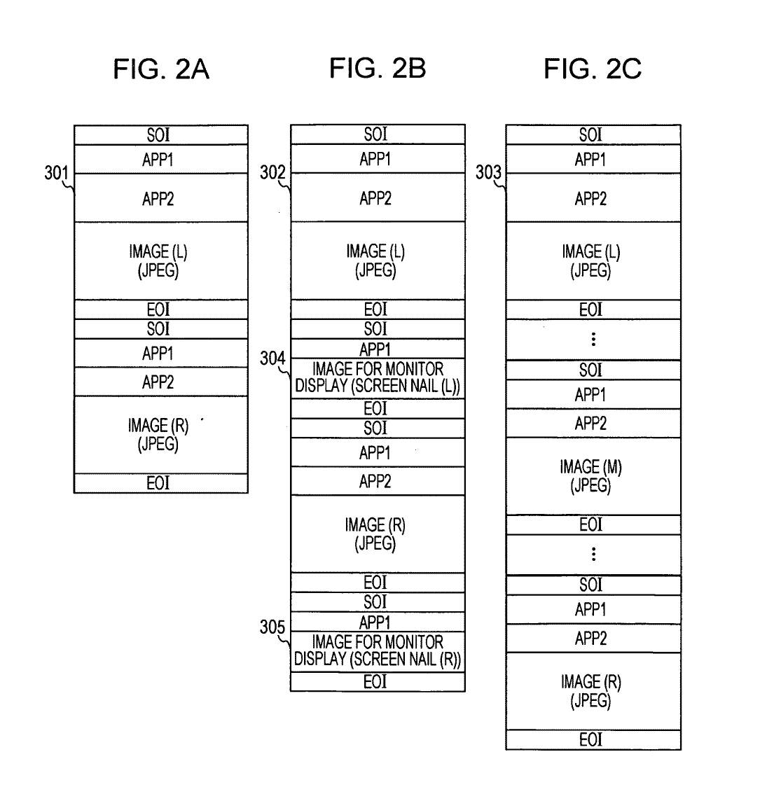

FIGS. 2A to 2C are schematic diagrams showing an image file stored in the removable medium 192 according to the first embodiment of the present invention. In FIGS. 2A to 2C, an example of a file structure of a still image file based on a Multi Picture (MP) format for recording a plurality of still images as one file (extension: MPO) is shown. That is, an MP file (see “CIPA DC-007-2009 Multi Picture format”) is a file in which one or a plurality of images may be recorded subsequent to a leading image.

FIG. 2A shows an example of a file structure of a 2-viewpoint image (a left eye image and a right eye image for displaying a stereoscopic image) and FIG. 2B shows an example of a file structure of a 2-viewpoint image associated with an image for monitor display (a so-called screen nail image). FIG. 2C shows an example of a file structure of a multi-viewpoint image (multi-viewpoint image of 3-viewpoint or more).

In the file structure shown in FIGS. 2A to 2C, a Start Of Image (SOI) is a segment indicating start of an image, which is arranged at the forefront of a JPEG image or an image for monitor display. An End Of Image (EOI) is a segment indicating end of an image, which is arranged at the end of a JPEG image or an image for monitor display.

Between the SOI and the EOI, Application Segment (APP) 1, APP2 and JPEG image data are arranged. APP1 and APP2 are application marker segments for storing auxiliary information of JPEG image data. Marker segments of DQT, DHF, SOF and Start of Scan (SOS) are inserted in front of compression image data and are not shown. The recording order of Define Quantization Table (DQT), Define Huffman Table (DHF) and Start of Frame (SOF) is arbitrary. In images 304 and 305 for monitor display shown in FIG. 2B, APP2 including MP format auxiliary information may not be recorded. However, the image for monitor display is subordinate to APP2 of a main image (original image) is recorded. In addition, the image for monitor display is equal to the main image in terms of aspect ratio, and, for example, has 1920 pixels in the horizontal direction and suits an aspect ratio of the main image in the vertical direction.

APP2 (301 to 303) located on the uppermost sides of the file structures have important roles representing the file structures, in which the image position (offset address) of each viewpoint, the byte size, or information indicating whether or not it is a representative image is recorded.

Now, recording of multi-viewpoint images will be briefly described by referring to “6.2.2.2 stereoscopic image” and “A.2.1.2.3 selection of representative image” of “CIPA DC-007-2009 Multi Picture Format”. The following (1) is described in “6.2.2.2 stereoscopic image” and the following (2) is described in “A.2.1.2.3 selection of representative image”.

(1) In a stereoscopic image, a viewpoint number is applied toward a subject in ascending order from a left viewpoint to a right viewpoint.

(2) In the case where a stereoscopic image is recorded, it is recommended that an image used as a representative image uses an image having a viewpoint number represented by (number of viewpoints/2) or ((number of viewpoints/2)+1) if the number of viewpoints is an even number and uses an image (image near the center of all viewpoints) having a viewpoint number represented by (number of viewpoints/2+0.5) if the number of viewpoints is an odd number.

In the case of following this rule, since a left viewpoint image is packed to a higher-level address, the left viewpoint image is first subjected to a synthesis process or an encoding process. In this case, for example, if a representative image which is a central image is review-displayed, the review display of the representative image is not performed until the synthesis process or the like of the central image is finished. In the first embodiment of the present invention, an example of rapidly displaying the representative image after finishing the imaging action is described. However, the display timing of the representative image may be appropriately changed according to the tastes or the liking of the user. The review display is a display operation for automatically displaying captured images generated by the imaging process for a predetermined period of time after finishing the imaging process of the captured image by a recording instruction operation when the recording instruction operation of a still image is performed in a state in which a photographing mode of a still image is set by the recording instruction operation.

### Selection Example of Image to be Recorded

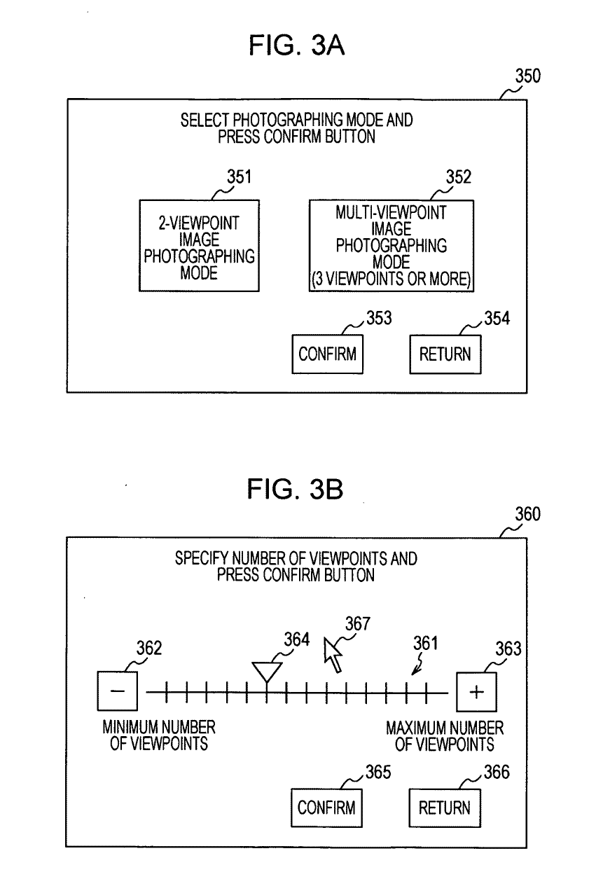

FIGS. 3A and 3B are diagrams showing a display example of a setting screen for setting a photographing mode of a multi-viewpoint image by the imaging device 100 according to the first embodiment of the present invention. The setting screen is, for example, displayed on the LCD 172 according to a user operation from the operation unit 182.

FIG. 3A shows a display example of a setting screen 350 for setting any one of a 2-viewpoint image photographing mode and a multi-viewpoint image photographing mode as a photographing mode. In the setting screen 350, a 2-viewpoint image photographing mode selection button 351, a multi-viewpoint image photographing mode selection button 352, a confirm button 353 and a return button 354 are provided.

The 2-viewpoint image photographing mode selection button 351 is pressed when the 2-viewpoint image photographing mode is set as the photographing mode of the multi-viewpoint image. The 2-viewpoint image photographing mode is a photographing mode for photographing a 2-viewpoint image. When the 2-viewpoing image photographing mode is set by the pressing operation of the 2-viewpoing image photographing mode selection button 351, an image generated by the imaging unit 110 is recorded as an image file of a 2-viewpoint image shown in FIG. 2A or 2B.

The multi-viewpoint image photographing mode selection button 352 is pressed when a multi-viewpoint image photographing mode is set as the photographing mode of the multi-viewpoint image. The multi-viewpoint image photographing mode is a photographing mode for photographing a multi-viewpoint image of 3 viewpoints or more, the number of viewpoints to be recorded may be set in advance or the number of viewpoints to be recorded may be changed by a user operation. This change example is shown in FIG. 3B. If the multi-viewpoint image photographing mode is set by the pressing operation of the multi-viewpoint image photographing mode selection button 352, an image generated by the imaging unit 110 is recorded as an image file of a multi-viewpoint image shown in FIG. 2C.

The confirm button 353 is pressed when the selection is decided on after the pressing operation for selecting the 2-viewpoint image photographing mode or the multi-viewpoint image photographing mode. The return button 354 is pressed, for example, when returning to a display screen displayed immediately before.

FIG. 3B shows a display example of a setting screen 360 for setting the number of viewpoints to be recorded by a user operation if the multi-viewpoint image photographing mode is set. In the setting screen 360 shown in FIG. 3B, a number-of-viewpoints axis 361, a minus display region 362, a plus display region 363, a specified position marker 364, a confirm button 365 and a return button 366 are provided.

The number-of-viewpoints axis 361 represents the number of viewpoints to be specified by a user operation and each scale mark on the number-of-viewpoints axis 361 corresponds to the value of the viewpoint. For example, among scale marks on the number-of-viewpoints axis 361 the scale mark closest to the minus display region 362 corresponds to 3 viewpoints. Among scale marks on the number-of-viewpoints axis 361, the scale mark closest to the plus display region 363 corresponds to maximum number of viewpoints (for example, 15 viewpoints).

The specified position marker 364 indicates the number of viewpoints specified by a user operation. For example, through an operation using a cursor 367 or a touch operation (in the case of including a touch panel), the specified position marker 364 is moved to a position on the number-of-viewpoints axis 361 desired by the user so as to specify the number of viewpoints to be recorded.

A confirm button 365 is pressed when the specification is decided on after the specified position marker 364 is moved to the position on the number-of-viewpoints axis 361 desired by the user. A return button 366 is pressed, for example, when returning to a display screen displayed immediately beforehand.

Imaging action Example of Multi-viewpoint Images and Notification Example of Progress Situation

FIGS. 4A and 4B are schematic diagrams showing an imaging action example and a notification example of a progress situation of the imaging action when a multi-viewpoint image is generated using the imaging device 100 according to the first embodiment of the present invention.

FIG. 4A schematically shows the case where the imaging action is viewed from an upper surface when the multi-viewpoint images are generated using the imaging device 100. That is, FIG. 4A shows an example of generating the multi-viewpoint image when the user performs an operation (a so-called panning operation (swing operation)) for moving the imaging device 100 in the horizontal direction (direction denoted by an arrow 370) based on an imaging position of the imaging device 100. In this case, an angle of view (angle of view of the horizontal direction) of the imaging device 100 is a and a range (imaging range) as an object to be captured by a series of panning operations is schematically shown by a thick dotted line 371.

FIG. 4B shows a display example of a progress situation notification screen 380 displayed on the LCD 172 when the multi-viewpoint image photographing mode (3 viewpoints or more) is set. In the progress situation notification screen 380, a progress bar 381 notifying the progress situation of imaging actions of multi-viewpoint image and operation assisting information 382 and 383 are provided.

The progress bar 381 is a bar graph for notifying the user of the progress situation of the user operation (the panning operation of the imaging device 100) when the multi-viewpoint image photographing mode is set. Specifically, the progress bar 381 indicates to what extent the current operation amount (a gray portion 384) of the entire operation amount (for example, a rotation angle of the panning operation) necessary for the multi-viewpoint image photographing mode has progressed. In addition, in the progress bar 381, based on the results of detecting the movement amount and the movement direction between adjacent captured images on a time axis, the CPU 160 calculates the current operation amount so as to change the display state based on the current operation amount. As the movement amount and the movement direction, for example, a motion vector (Global Motion Vector (GMV)) corresponding to motion of the entire captured image generated by the movement of the imaging device 100 is detected. In addition, based on an angular velocity detected by the gyro sensor 115, the CPU 160 may calculate the current operation amount. Using the results of detecting the movement amount and the movement direction and the angular velocity detected by the gyro sensor 115, the CPU 160 may calculate the current operation amount. By displaying the progress bar 381 while photographing the multi-viewpoint image, the user may easily check to what extent the panning operation is necessary to be performed.

The operation assisting information 382 and 383 is to assist a user operation (the panning operation of the imaging device 100) when the multi-viewpoint image photographing mode is set. As the operation assisting information 382, for example, a message assisting the user operation is displayed. As the operation assisting information 383, for example, an arrow (arrow indicating the operation direction) assisting the user operation is displayed.

Imaging action Example of Multi-viewpoint Images and Recording Example of Captured image Generated by Imaging Action

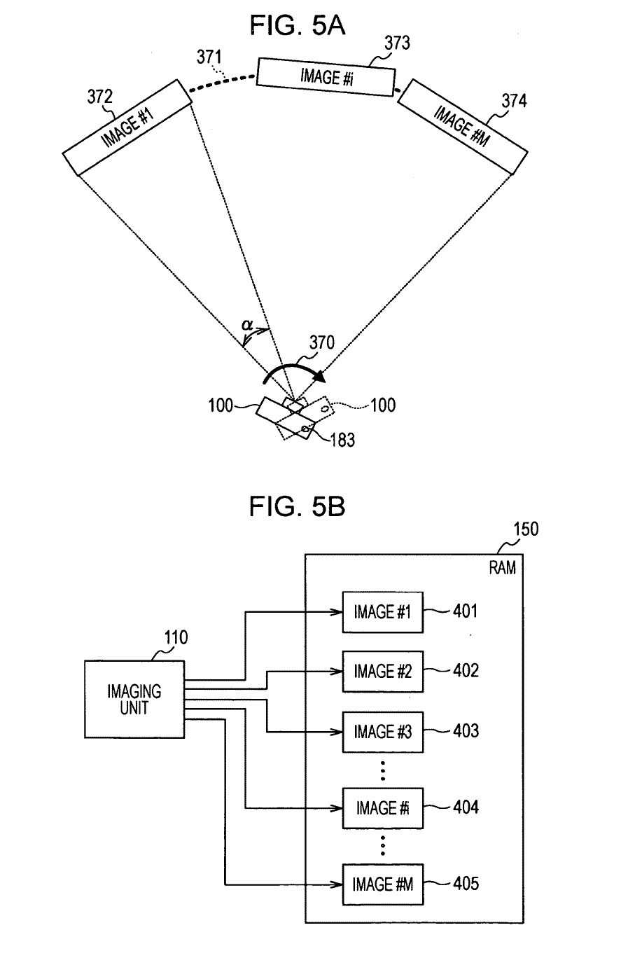

FIGS. 5A and 5B are schematic diagrams showing an imaging action example and an example of the flow of the plurality of captured images generated by the imaging action when a multi-viewpoint image is generated using the imaging device 100 according to the first embodiment of the present invention.

FIG. 5A schematically shows the case where the imaging action is viewed from an upper surface when the multi-viewpoint image is generated using the imaging device 100. FIG. 5A is equal to the example shown in FIG. 4A except that rectangles 372 to 374 are added. That is, in FIG. 5A, the captured images (images (#1) 401, (#i) 404, (#M) 405) shown in FIG. 5B are virtually arranged on a circle (on the dotted line 371) and positional relationships when the imaging ranges are viewed from the upper surface are schematically denoted by rectangles 372 to 374. In the rectangles 372 to 374, symbols #1, #i, #M corresponding thereto are given. A plurality of captured images generated in this way is captured images generated by performing the imaging actions such that the same subject is included in at least a partial region in the horizontal direction.

FIG. 5B schematically shows a state in which the captured images (images (#1) 401 to (#M) 405) generated by the panning operation shown in FIG. 5A is held in the RAM 150. That is, as shown in FIG. 5A, during the panning operation of the imaging device 100 by the user, the imaging unit 110 sequentially generates the images (#1) 401 to (#M) 405. Here, the images (#1) 401 to (#M) 405 are a plurality of captured images having an offset in the horizontal direction and, for example, an upper limit number thereof may be about 70 to 100. Numbers are given to the images (#1) 401 to (#M) 405 in time series. If a recording instruction operation for multi-viewpoint imaging is performed in the imaging device 100, a plurality of captured images generated during the imaging action is sequentially recorded in the RAM 150. The recording instruction operation for multi-viewpoint imaging may be performed, for example, by maintaining the state of pressing the shutter button 183 in a state in which the multi-viewpoint image recording mode is set.

### Generation Example of Multi-viewpoint Image

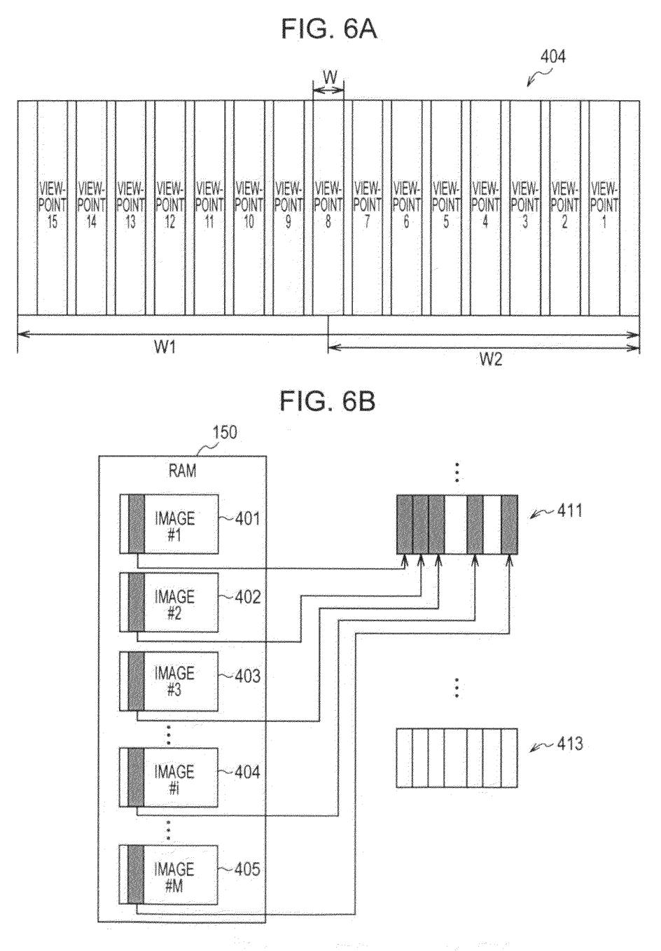

FIGS. 6A, 6B, 7, and 8A to 8C are schematic diagrams showing a generation method when a multi-viewpoint image is generated by the imaging device 100 according to the first embodiment of the present invention. In this example, an example of generating an image configured by 15 viewpoints as a multi-viewpoint image is shown.

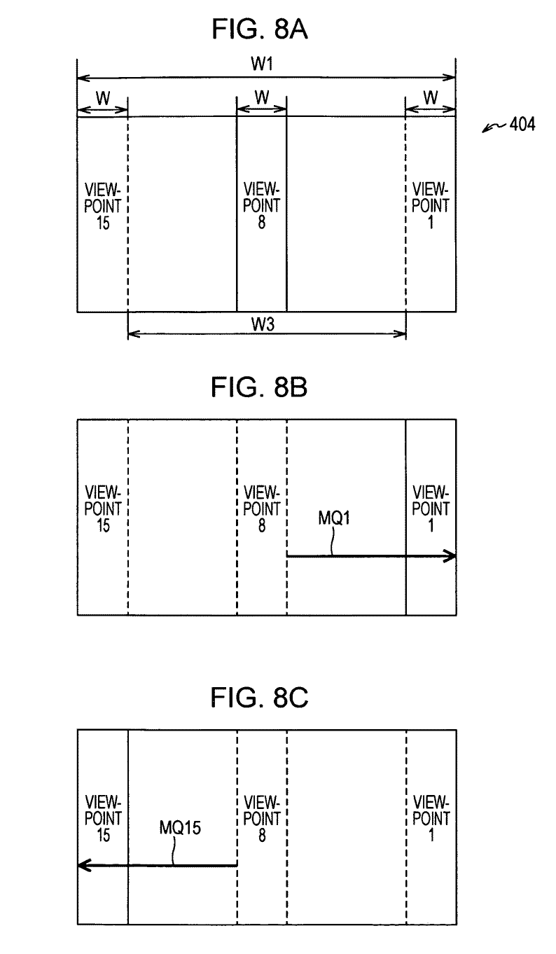

FIG. 6A schematically shows image (#i) 404 generated by the imaging unit 110 by a rectangle. In FIG. 6A, in the image (#i) 404, an extraction region of an image (an image region of each viewpoint to be synthesized) used when generating the multi-viewpoint image is represented by a viewpoint number (viewpoints 1 to 15) of the multi-viewpoint image corresponding thereto. Here, the length of the horizontal direction of the image (#i) 404 is W1 and the length of the horizontal direction of an extraction region (strip region) used for synthesis of a central image (a multi-viewpoint image of viewpoint 8) is w. In this case, the extraction region of the central image is decided on as the center of the horizontal direction of the image (#1) 404 (that is, W1=W2×2). The lengths of the horizontal direction of the extraction regions of the viewpoints of the image (#i) 404 are identical (that is, w). Here, the length w of the horizontal direction of the extraction region of each viewpoint largely depends on the movement amount between images of the images (#1) 401 to (#M) 405 generated by the imaging unit 110. The method of calculating the length w of the horizontal direction of the extraction region of each viewpoint and the position of the extraction region of each viewpoint in the images (#1) 401 to (#M) 405 will be described in detail with reference to FIGS. 7 and 8A to 8C.

FIG. 6B schematically shows a generation method of generating a multi-viewpoint image using the images (#1) 401 to (#M) 405 held in the RAM 150. In FIG. 6B, an example of generating a viewpoint j image 411 using the images (#1) 401 to (#M) 405 held in the RAM 150 is shown. In FIG. 6B, an image region as an object to be synthesized of the viewpoint j image among the images (#1) 401 to (#M) 405 held in the RAM 150 is represented by gray. With respect to each of the images (#1) 401 to (#M) 405 held in the RAM 150, a multi-viewpoint image is generated using at least a partial image region.

Next, a setting method of setting an extraction region for the images (#1) 401 to (#M) 405 held in the RAM 150 will be described.

FIG. 7 is a schematic diagram showing the imaging element 111 and a relationship between a focal length and an angle view according to the first embodiment of the present invention. The imaging element 111 and the optical unit 112 are included in the imaging unit 110. Here, the width of the imaging element 111 is set to the width IE1 [mm] of the imaging element. In this case, the width IE1 of the imaging element may be obtained by the following equation 1.

IEl=p×h (1)

In addition, p [μm] denotes a value indicating the pixel pitch of the imaging element 111 and h [pixel] denotes a value indicating the number of horizontal pixels of the imaging element 111.

The angle of view of the imaging device 100 of the example shown in FIG. 7 is set to α [deg]. In this case, the angle α of view may be obtained by the following equation 2.

α=(180/π)×2×tan−1((p×h×10−3)/(2×f)) (2)

In addition, f [mm] denotes a value indicating a focal length of the imaging device 100.

By using the calculated angle α of view, the angle of view per pixel (pixel density) μ [deg/pixel] configuring the imaging element 111 may be obtained by the following equation 3.

μ=α/h (3)

Here, if the multi-viewpoint image photographing mode is set in the imaging device 100, the consecutive speed (that is, the number of frames per second) of the image in the multi-viewpoint image photographing mode is set to s [fps]. In this case, the length w [pixel] of the horizontal direction (width of the extraction region) of the extraction region (maximum extraction region) of one viewpoint of one captured image may be obtained by the following equation 4.

w=(d/s)×(1×μ) (4)

In addition, d [deg/sec] denotes a value indicating a shake angular velocity of a user who operates the imaging device 100. By using the shake angular velocity d of the user who operates the imaging device 100, the width w of the extraction region (width of the maximum extraction region) may be obtained.

FIGS. 8A to 8C show a method of calculating a shift amount of the extraction region as objects to be synthesized of the multi-viewpoint image of the captured image (image #i) 404) held in the RAM 150. FIG. 8A shows an extraction region of a central image (multi-viewpoint image of viewpoint 8), FIG. 8B shows an extraction region of a leftmost-viewpoint image (multi-viewpoint image of viewpoint 1), and FIG. 8C shows an extraction region of a rightmost-viewpoint image (multi-viewpoint image of viewpoint 15).

As described above, if the synthesis process of the multi-viewpoint image is performed, images (strip images) as objects to be synthesized of the multi-viewpoint image are extracted from each of the captured images (images (#1) 401 to (#M) 405) generated by the imaging unit 110 and held in the RAM 150. That is, images (strip images) as objects to be synthesized are sequentially extracted while shifting the position of the extraction region (strip region) of one captured image held in the RAM 150. In this case, the extracted images are synthesized so as to be superimposed based on correlation between images. Specifically, the movement amount and the movement direction between two adjacent captured images (that is, relative displacement between adjacent captured images) on a time axis are detected. Based on the detected movement amount and movement direction (movement amount and movement direction between the adjacent images), the extracted images are synthesized such that the overlapped regions are superimposed on each other so as to generate the multi-viewpoint image.

Now, the method of calculating the size and position of the extraction region (strip region) of one captured image held in the RAM 150 and the shift amount of the viewpoint j will be described.

After the imaging process by the imaging unit 110 and the recording process in the RAM 150 are finished, it is calculated which region is an extraction region, in each of the plurality of captured images held in the RAM 150. Specifically, as shown in Equation 4, the width of the extraction region is calculated and the position of the horizontal direction of the extraction region used for the synthesis of the central image (multi-viewpoint image of viewpoint 8) is set to the central position of the captured images held in the RAM 150.

Here, the position of the horizontal direction of the extraction region used for the synthesis of the multi-viewpoint image other than the central image (multi-viewpoint image of viewpoint 8) is calculated based on the position of the horizontal direction of the extraction region used for the synthesis of the central image (multi-viewpoint image of viewpoint 8). Specifically, the position shifted from the first position (central position) is calculated according to a difference in viewpoint number between the central viewpoint (viewpoint 8) and the viewpoint j. That is, the shift amount MQj of the viewpoint j may be obtained by the following equation 5.

MQj=(CV−OVj)×β (5)

In addition, CV denotes a value indicating a central viewpoint of the multi-viewpoint image, and OVj denotes a value indicating a viewpoint (viewpoint j) other than the central viewpoint of the multi-viewpoint image. In addition, β denotes a value indicating the shift amount (strip position shift amount) of the position of the extraction region per viewpoint. In addition, the size (strip size) of the extraction region is not changed.

Now, the method of calculating the strip position shift amount β will be described. The strip position shift amount β may be obtained by the following equation 6.

β=(W1−w×2)/VN (6)

In addition, W1 denotes a value indicating a horizontal size per captured image held in the RAM 150, w denotes a value indicating the width of the extraction region (width of the maximum extraction region), and VN denotes a value indicating the number of viewpoints of the multi-viewpoint image. That is, a value obtained by dividing W3 (=W1−w×2) shown in FIG. 8A by the number (15) of viewpoints is calculated as the strip position shift amount β.

In this way, the strip position shift amount β is calculated such that the image (strip image) extracted when the synthesis process of the leftmost-viewpoint image or the rightmost-viewpoint image is arranged at the positions of at least the left end and the right end of the captured image held in the RAM 150.

In addition, if the synthesis process of a panoramic plane image (two-dimensional image) is performed, the central strip image (image corresponding to viewpoint 8) corresponding to the width w of the extraction region (width of the maximum extraction region) is sequentially extracted and synthesized. If the synthesis process of the 2-viewpoint image is performed, two extraction regions are set such that the shift amount (offset amount) OF from the central strip image is identical at the left viewpoint and the right viewpoint. In this case, an allowable offset amount (minimum strip offset amount) OFmin [pixel] in the shake angular velocity d of the user who operates the imaging device 100 may be obtained by the following equation 7.

OFmin=w/2 (7)

In addition, the minimum strip offset amount OFmin is the minimum allowable strip offset amount in which a left-eye strip image and a right-eye strip image are not superimposed (overlapped).

A maximum allowable strip offset amount (maximum strip offset amount) OFmax which does not protrude the extraction region used for the synthesis process of the 2-viewpoint image to the outside of the image region of the captured image held in the RAM 150 may be obtained by the following equation 8.

OFmax=(t−OFmin)/2 (8)

Here, t [pixel] denotes a horizontal valid size of one image generated by the imaging unit 110. The horizontal valid size t corresponds to the number of horizontal pixels which is the horizontal width of the captured image held in the RAM 150.

### Recording Process Example of Multi-viewpoint Image

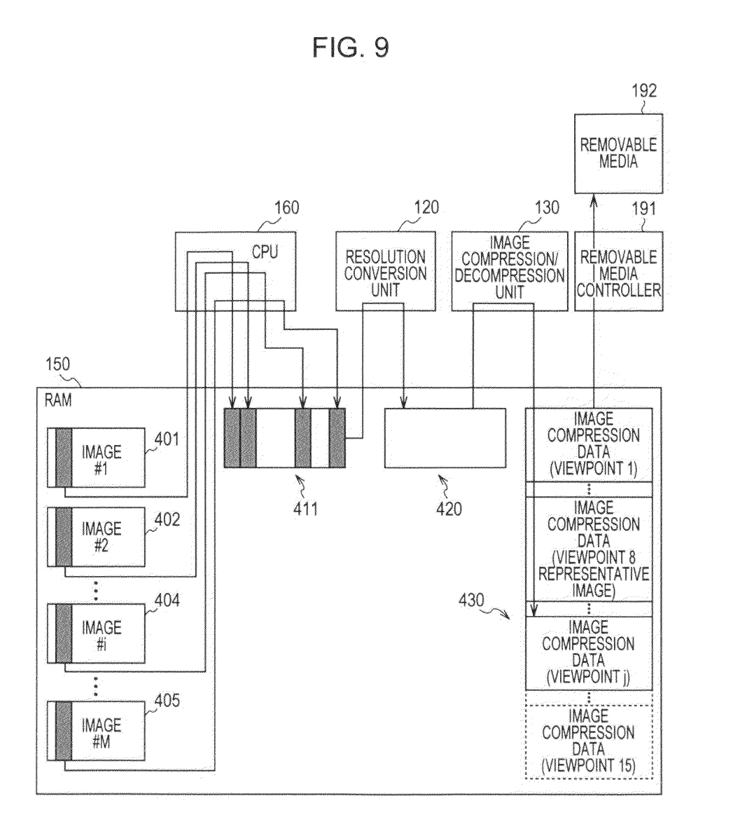

FIG. 9 is a schematic diagram showing the flow until the multi-viewpoint image generated by the imaging device 100 according to the first embodiment of the present invention is recorded in the removable medium 192. In FIG. 9, an example of the flow of the data on the RAM 150 in the case where a viewpoint j image 411 generated using the images (#1) 401 to (#M) 405 held in the RAM 150 is recorded as an MP file 420 (extension: MPO). In addition, the images (#1) 401 to (#M) 405 shown in FIG. 9 are identical to those of FIG. 6A.

As described above, the images (#1) 401 to (#M) 405 generated by the imaging unit 110 are sequentially recorded in the RAM 150. Subsequently, in each of the images (#1) 401 to (#M) 405 held in the RAM 150, the CPU 160 calculates the extraction region of the viewpoint j and acquires the image included in the extraction region. Subsequently, by using the image acquired from the extraction region of each of the images (#1) 401 to (#M) 405, the CPU 160 generates the synthesized image (viewpoint j image 411) of the viewpoint j. Although the example in which the CPU 160 generates the synthesized image of the multi-viewpoint image is described in this example, image synthesis hardware or software (accelerator) may be separately provided and the synthesized image of the multi-viewpoint image may be generated.

Subsequently, the resolution conversion unit 120 performs resolution conversion with respect to the viewpoint j image 411 and sets a final image (viewpoint j image 420) of the viewpoint j. Subsequently, the image compression/decompression unit 130 compresses the viewpoint j image 420 to JPEG format image data. Subsequently, the CPU 160 performs a packing process (packing process such as header addition) of the viewpoint j image 420 of the JPEG to the MP file 430. The same process is similarly performed with respect to the generation of other multi-viewpoint images. If the synthesis process of all multi-viewpoint images is finished, the removable media controller 191 records the MP file 430 in the removable medium 192 based on the control of the CPU 160.

FIG. 9 schematically shows a state in which the recording of the multi-viewpoint image of the viewpoint j of the MP file 430 is finished. That is, in the MP file 430, the region of the multi-viewpoint image in which recording is finished is denoted by a solid line and the region of the multi-viewpoint image in which recording is not finished is denoted by a dotted line.

### Display Process Example of Representative Image of Multi-viewpoint Image

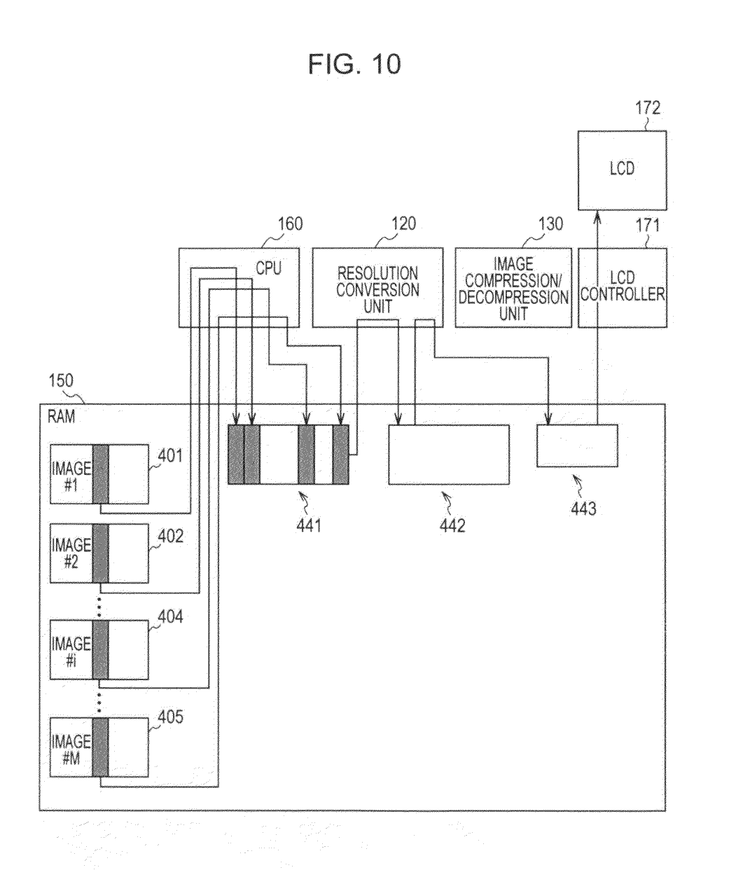

FIG. 10 is a schematic diagram showing the flow until a representative image of the multi-viewpoint images generated by the imaging device 100 according to the first embodiment of the present invention is displayed. FIG. 10 shows an example of the flow of data on the RAM 150 in the case where the viewpoint 8 image generated using the images (#1) 401 to (#M) 405 held in the RAM 150 is displayed on the LCD 172 as a representative image. The images (#1) 401 to (#M) 405 shown in FIG. 10 are identical to those of FIG. 6A.

Since the generation of the synthesized image (representative image 441) of the viewpoint 8 and the final image (representative image 442) of the viewpoint 8 is equal to the example shown in FIG. 9, the description will be omitted herein.

After the representative image 442 is generated, the resolution conversion unit 120 performs resolution conversion with respect to the representative image 442 to become an optimal screen size to the display and sets a display image (representative image 443) of the viewpoint 8. Subsequently, the LCD controller 171 displays the representative image 443 on the LCD 172 based on the control of the CPU 160. That is, the representative image 443 is review-displayed. Even after review display, the generated representative image 442 is held in the RAM 150 until the packing process to the MP file 430 shown in FIG. 9 is performed. Accordingly, it is not necessary to perform the synthesis process with respect to the representative image 442 again and it is possible to reduce the overhead of the synthesis processing time.

In this way, the multi-viewpoint images are generated using the plurality of images generated by the imaging unit 110. A representative image of the generated multi-viewpoint images is initially displayed on the LCD 172.

### Functional Configuration Example of Imaging Device

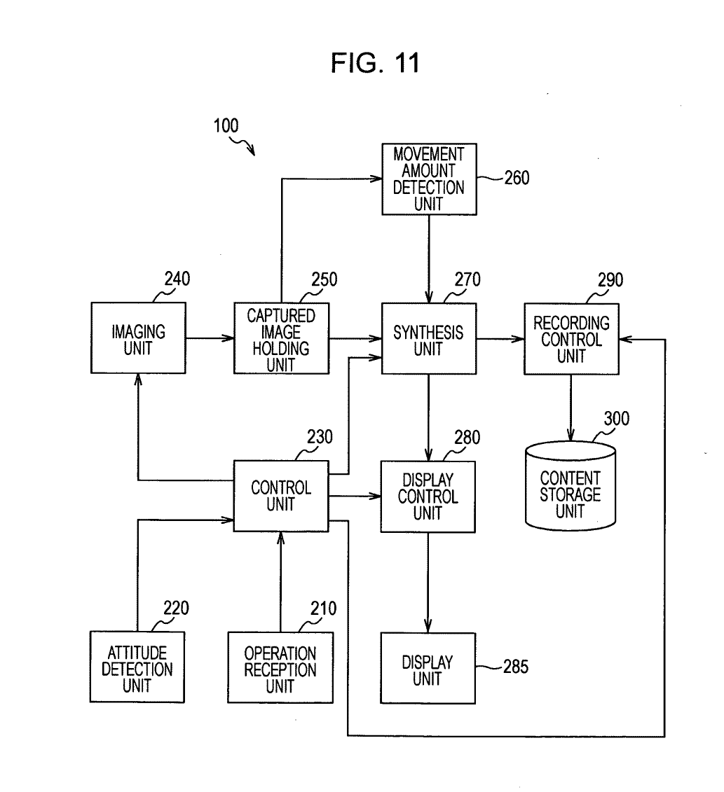

FIG. 11 is a block diagram showing a functional configuration example of the imaging device 100 according to the first embodiment of the present invention. The imaging device 100 includes an operation reception unit 210, an attitude detection unit 220, a control unit 230, an imaging unit 240, a captured image holding unit 250, a movement amount detection unit 260, a synthesis unit 270, a display control unit 280, a display unit 285, a recording control unit 290, and a content storage unit 300.

The operation reception unit 210 receives operation content operated by the user and supplies an operation signal corresponding to the received operation content to the control unit 230. The operation reception unit 210, for example, corresponds to the input control unit 181 and the operation unit 182 shown in FIG. 1.

The attitude detection unit 220 detects a change in attitude of the imaging device 100 by detecting acceleration, motion, inclination and the like of the imaging device 100 and outputs attitude change information of the detected change in attitude to the control unit 230. In addition, the attitude detection unit 220 corresponds to the gyro sensor 115 shown in FIG. 1.

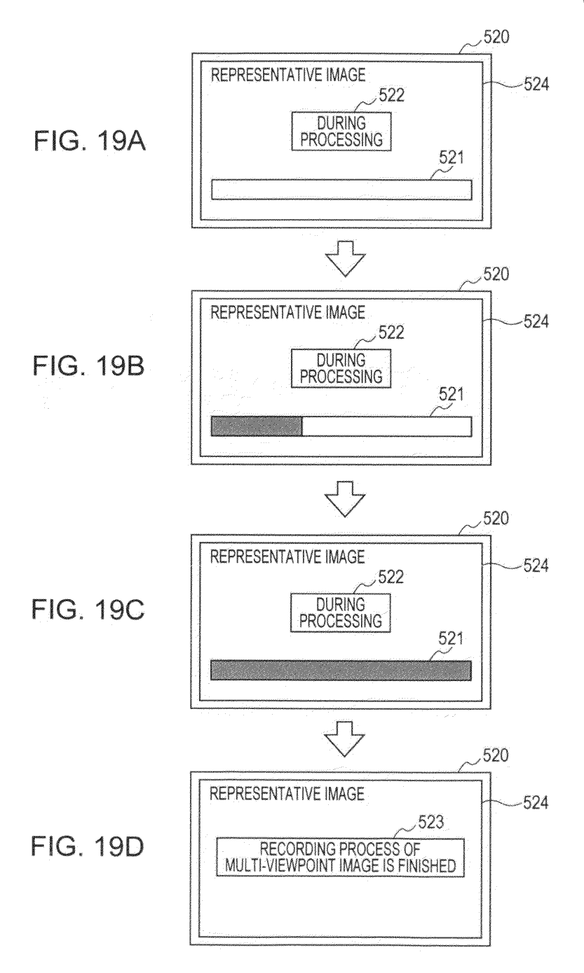

The control unit 230 controls the units of the imaging unit 100 based on the operation content from the operation reception unit 210. For example, when a setting operation of a photographing mode is received by the operation reception unit 210, the control unit 230 sets a photographing mode corresponding to the setting operation. For example, the control unit 230 analyzes the change amount (movement direction, the movement amount, or the like) of the attitude of the imaging device 100 based on the attitude change information output from the attitude detection unit 220 and outputs the analyzed result to the synthesis unit 270 and the display control unit 280. For example, the control unit 230 performs control for displaying a multi-viewpoint image which is located at a predetermined order (for example, a central viewpoint) among the plurality of multi-viewpoint images as an object to be generated by the synthesis unit 270 on the display unit 285 as a representative image, after a process of generating a plurality of captured images by the imaging unit 240 is finished. After the representative image is displayed, the control unit 230, for example, performs control for sequentially displaying at least a part of the generated multi-viewpoint images on the display unit 285 according to a predetermined rule (for example, each viewpoint). For example, the control unit 230 performs control for displaying information (for example, the progress bar 521 shown in FIGS. 19A to 21D) about progress of the generation of the multi-viewpoint image by the synthesis unit 270 on the display unit 285, after the process of generating the plurality of captured images by the imaging unit 240 is finished. In this case, the control unit 230, for example, performs control for displaying the progress information on the display unit 285 immediately after the process of generating the plurality of captured images by the imaging unit 240 is finished. In addition, the control unit 230 corresponds to the CPU 160 shown in FIG. 1.

The imaging unit 240 captures a subject and generates captured images based on the control of the control unit 230 and supplies the generated captured images to the captured image holding unit 250. In addition, if a 2-viewpoint image photographing mode or a multi-viewpoint image photographing mode is set, the imaging unit 240 captures the subject, generates a plurality of consecutive captured images in time series, and supplies the generated captured images to the captured image holding unit 250. In addition, the imaging unit 240 corresponds to the imaging unit 110 shown in FIG. 1.

The captured image holding unit 250 is an image memory for holding the captured images generated by the imaging unit 240 and supplies the held captured image to the synthesis unit 270. The captured image holding unit 250 corresponds to the RAM 150 shown in FIG. 1.

The movement amount detection unit 260 detects the movement amount and the movement direction between the captured images adjacent on the time axis with respect to the captured images held in the captured image holding unit 250 and outputs the detected movement amount and the movement direction to the synthesis unit 270. For example, the movement amount detection unit 260 performs a matching process (that is, a matching process of discriminating a photographing region of the same subject) between pixels configuring two adjacent captured images and calculates the number of pixels moved between the captured images. In this matching process, fundamentally, a process of supposing that the subject is stopped is performed. If a movable body is included in the subject, a motion vector different from the motion vector of the entire captured image is detected and the motion vector corresponding to the movable body is processed as separate to the detection object. That is, only the motion vector (GMV: global motion vector) corresponding to the motion of the entire captured image generated by the movement of the imaging device 100 is detected. In addition, the movement amount detection unit 260 corresponds to the CPU 160 shown in FIG. 1.

The synthesis unit 270 generates the multi-viewpoint image using the plurality of captured images held in the captured image holding unit 250 based on the control of the control unit 230 and supplies the generated multi-viewpoint image to the display control unit 280 and the recording control unit 290. That is, the synthesis unit 270 calculates the extraction regions in the plurality of captured images held in the captured image holding unit 250 based on the analysis result (analysis result of the change amount of the attitude of the imaging device 100) output from the control unit 230. The synthesis unit 270 extracts the images (strip images) from the extraction regions of the plurality of captured images and synthesizes the extracted images so as to generate the multi-viewpoint image. In this case, the synthesis unit 270 synthesizes the extracted images so as to be superimposed based on the movement amount and the movement direction output from the movement amount detection unit 260 in order to generate the multi-viewpoint image. The generated multi-viewpoint image is a plurality of synthesized images having an order relationship (each viewpoint) based on a predetermined rule. For example, the synthesis unit 270 initially generates the representative image immediately after the process of generating the plurality of captured images by the imaging unit 240 is finished. In addition, the initially generated image may be changed by the user operation or the setting content. In addition, the synthesis unit 270 corresponds to the resolution conversion unit 120, the RAM 150 and the CPU 160 shown in FIG. 1.

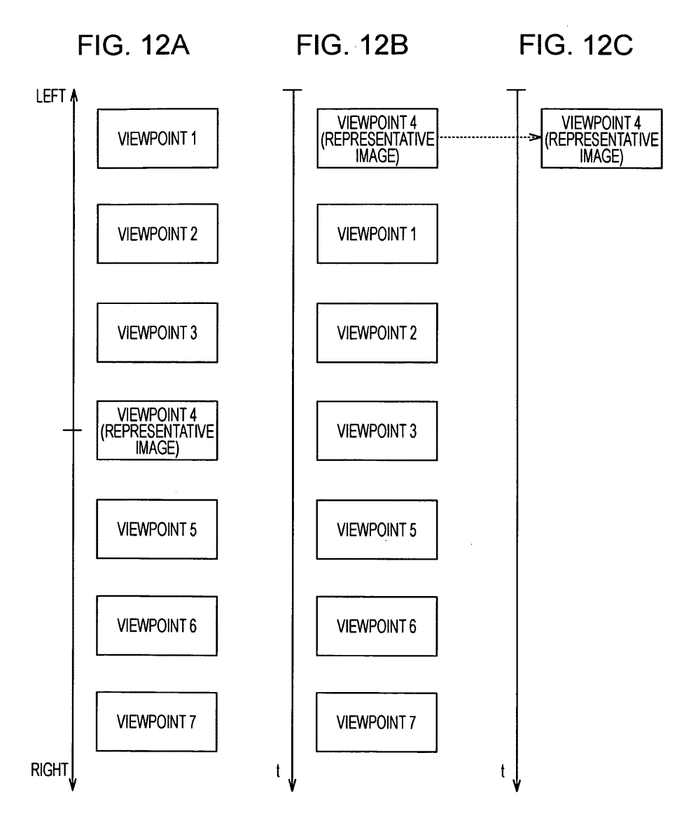

The display control unit 280 displays the multi-viewpoint image generated by the synthesis unit 270 on the display unit 285 based on the control of the control unit 230. For example, the display control unit 280 displays the multi-viewpoint image which is located at a predetermined order (for example, a central viewpoint) among the plurality of multi-viewpoint images as an object to be generated by the synthesis unit 270 on the display unit 285 as a representative image, after the process of generating the plurality of captured images by the imaging unit 240 is finished. After the representative image is displayed, the display control unit 280, for example, sequentially displays at least a part of the generated multi-viewpoint images on the display unit 285 according to a predetermined rule (for example, each viewpoint). For example, the display control unit 280 displays information (for example, the progress bar 521 shown in FIGS. 19A to 21D) about progress of the generation of the multi-viewpoint image by the synthesis unit 270 on the display unit 285, after the process of generating the plurality of captured images by the imaging unit 240 is finished. This display example will be described in detail with reference to FIGS. 12A to 21D. In addition, the display control unit 280 corresponds to the resolution conversion unit 120 and the LCD controller 171 shown in FIG. 1.

The display unit 285 displays an image supplied from the display control unit 280. Various menu screens or various images are displayed on the display unit 285. In addition, the display unit 285 corresponds to the LCD 172 shown in FIG. 1.

The recording control unit 290 performs control for recording the multi-viewpoint image generated by the synthesis unit 270 in the content storage unit 300 based on the control of the control unit 230. That is, the recording control unit 290 records the multi-viewpoint image on the recording medium as the MP file in a state in which representative image information indicating the representative image of the multi-viewpoint image and the order relationship (for example, a viewpoint number) of the multi-viewpoint image is associated with the generated multi-viewpoint image. In addition, the recording control unit 290 corresponds to the image compression/decompression unit 130 and the removable media controller 191 shown in FIG. 1.

The content storage unit 300 stores the multi-viewpoint image generated by the synthesis unit 270 as an image file (image content). The content storage unit 300 corresponds to the removable medium 192 shown in FIG. 1.

### Display Example of Representative Image

FIGS. 12A to 12C are diagrams showing a display example of the representative image displayed on the display unit 285 according to the first embodiment of the present invention. FIGS. 12A to 12C show an example of generating multi-viewpoint images of 7 viewpoints and recording the images in the content storage unit 300 in association with each other. In FIGS. 12A to 12C, in the multi-viewpoint image of 7 viewpoints, viewpoint numbers are assigned from the left viewpoint (viewpoint 1) to the right viewpoint (viewpoint 7) toward the subject in ascending order and the viewpoint numbers are described in rectangles indicating the images. In FIGS. 12A to 12C, an example of setting a central image (a multi-viewpoint image of viewpoint 4) among the multi-viewpoint images of 7 viewpoints as a representative image is shown. As the representative image, for example, an image adjacent to or close to the central image may be used.

FIG. 12A shows an example of a multi-viewpoint image as an object to be recorded in the content storage unit 300. In FIG. 12A, the images are arranged in order by viewpoint number.

In FIG. 12B, the multi-viewpoint images of viewpoints 1 to 7 generated by the synthesis process are arranged in the generation order thereof, after the imaging actions for generating the multi-viewpoint images of viewpoints 1 to 7 shown in FIG. 12A are finished. That is, the representative image (the multi-viewpoint image of viewpoint 4) initially displayed on the display unit 285 becomes an object to be initially synthesized. After the synthesis process of the representative image (the multi-viewpoint image of viewpoint 4) is finished, the synthesis process is performed with respect to the other multi-viewpoint images. For example, the synthesis process is performed in order of the viewpoint numbers (in order of viewpoints 1 to 3 and 5 to 7).

FIG. 12C shows an example of displaying the representative image as an image initially displayed on the display unit 285 during the synthesis process shown in FIG. 12B. By initially displaying the representative image, it is possible to rapidly and easily confirm the representative image of the multi-viewpoint images.

In the above description, the example of review displaying only the representative image if the multi-viewpoint images of 3 viewpoints or more are recorded. However, the multi-viewpoint images other than the representative image may be sequentially displayed according to the taste of the user. Hereinafter, an example of sequentially review displaying the multi-viewpoint images other than the representative image will be described.

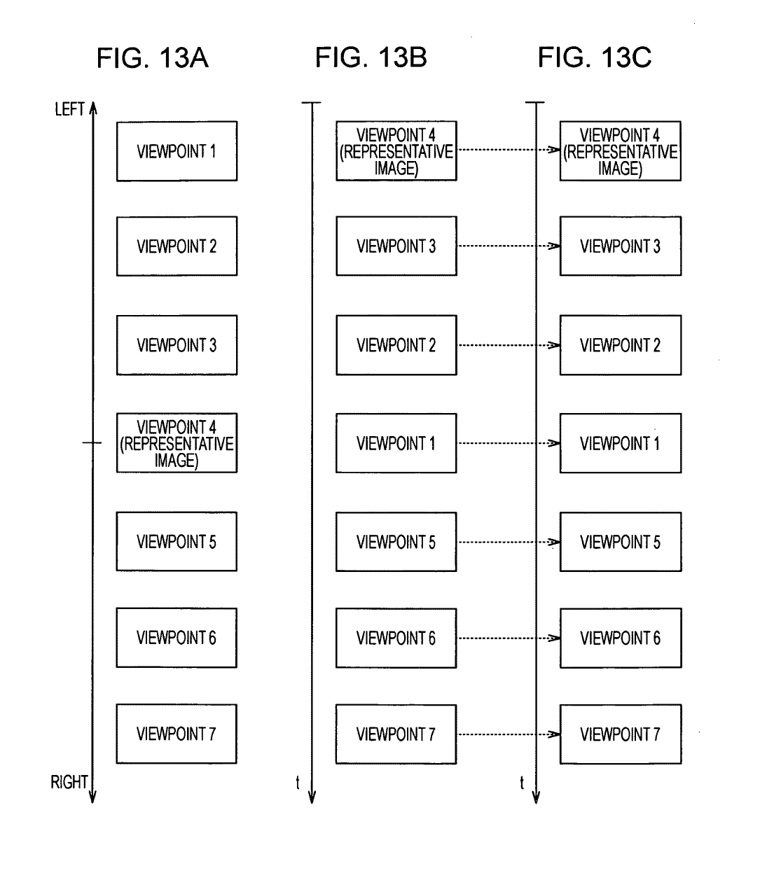

FIGS. 13A to 16C are diagrams showing a display transition example of multi-viewpoint images displayed on the display unit 285 according to the first embodiment of the present invention. In FIGS. 13A to 16C, similar to the example shown in FIGS. 12A to 12C, if the multi-viewpoint images of 7 viewpoints are recorded in the content storage unit 300 in association with each other, the example of setting the central image (the multi-viewpoint image of viewpoint 4) as the representative image is shown. In FIGS. 13A to 16C, similar to the example shown in FIGS. 12A to 12C, in the multi-viewpoint image of 7 viewpoints, viewpoint numbers are assigned from the left viewpoint (viewpoint 1) to the right viewpoint (viewpoint 7) toward the subject in ascending order and the viewpoint numbers are described in rectangles indicating the images.

In FIGS. 13A, 14A, 15A and 16A, the examples of the multi-viewpoint image as the object to be recorded in the content storage unit 300 are shown. FIGS. 13A, 14A, 15A and 16A are equal to the example shown in FIG. 12A.

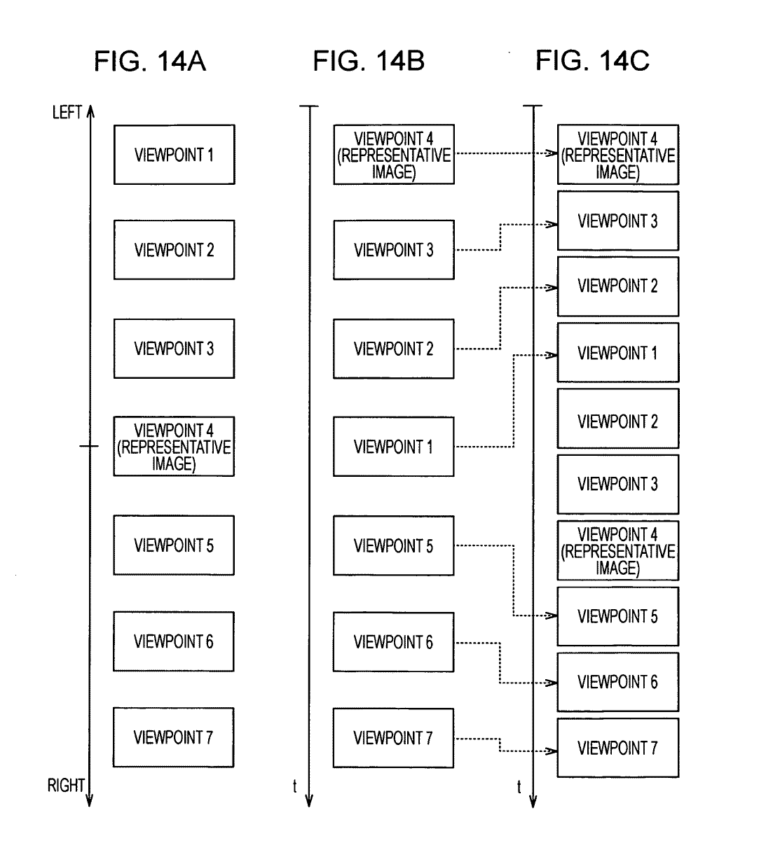

In FIGS. 13B and 14B, the multi-viewpoint images of viewpoints 1 to 7 generated by the synthesis process are arranged in the generation order thereof, after the imaging actions for generating the multi-viewpoint images of viewpoints 1 to 7 shown in FIG. 12A are finished. FIGS. 13B and 14B are equal to the example shown in FIG. 12B.

FIG. 13C shows the display transition example of the multi-viewpoint images displayed on the display unit 285 during the synthesis process shown in FIG. 13B. That is, FIG. 13C shows an example of sequentially review displaying the multi-viewpoint images generated by the synthesis process in the generation order thereof after the imaging actions for generating the multi-viewpoint images are finished.

FIG. 14C shows the display transition example of the multi-viewpoint images displayed on the display unit 285 during the synthesis process shown in FIG. 14B. That is, FIG. 14C shows an example of sequentially review displaying the multi-viewpoint images generated by the synthesis process in descending order by viewpoint number from the representative image after the imaging actions for generating the multi-viewpoint images are finished and sequentially review displaying the multi-viewpoint images in ascending order by viewpoint number after the above display.

The representative image may be initially review-displayed and the multi-viewpoint images generated by the synthesis process may be sequentially review-displayed according to a predetermined rule after the display of the representative image. Thus, it is possible to initially and rapidly confirm the representative image of the multi-viewpoint images and easily confirm the other multi-viewpoint images after confirmation.

For example, if the multi-viewpoint images are reproduced, on a selection screen for selecting a desired multi-viewpoint image, the representative image of the multi-viewpoint images may be list-displayed. Immediately after the imaging process by the imaging unit 240 is finished, the representative image of the multi-viewpoint images is review-displayed. For example, immediately after the imaging process by the imaging unit 240 is finished, the representative image is initially review-displayed. To this end, during review display it is possible to easily confirm the same image as the representative image list-displayed during reproduction. Thus, it is possible to reduce a sense of unease during reproduction.

By initially synthesizing and review displaying the representative image of the multi-viewpoint images immediately after the imaging process by the imaging unit 240 is finished, it is unnecessary for the user to wait for the time consumed for synthesizing the representative image from the left viewpoint image. To this end, timing when the user confirms the multi-viewpoint image as the object to be recorded may be hastened. Accordingly, it is possible to solve a problem that photographing cancel timing is delayed after confirming the multi-viewpoint image as the object to be recorded. The display order of multi-viewpoint images may be changed according to the taste of the user. Hereinafter, the display transition examples thereof will be described.

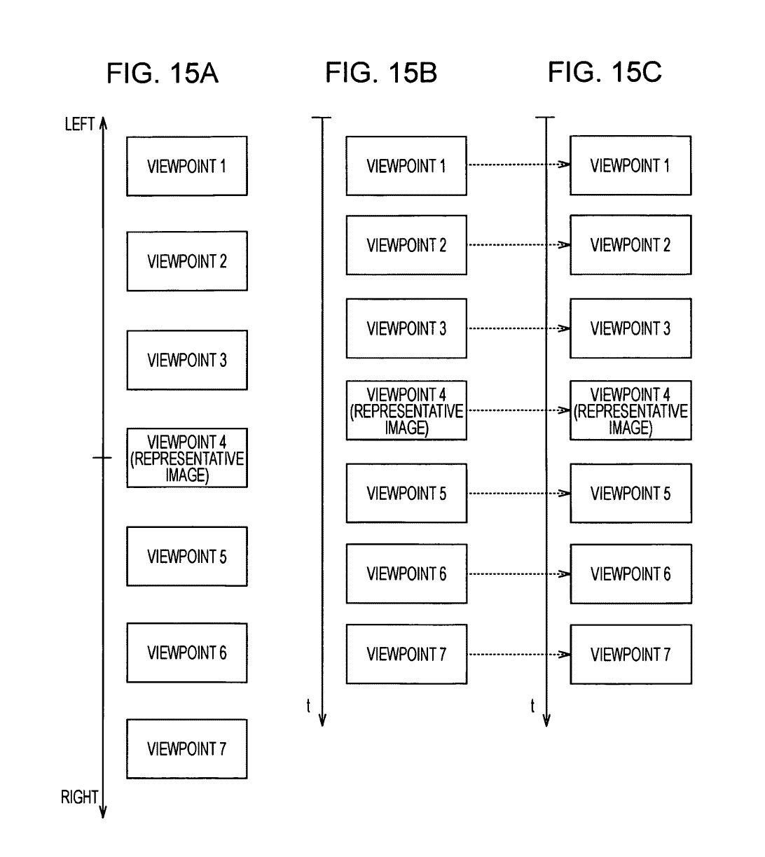

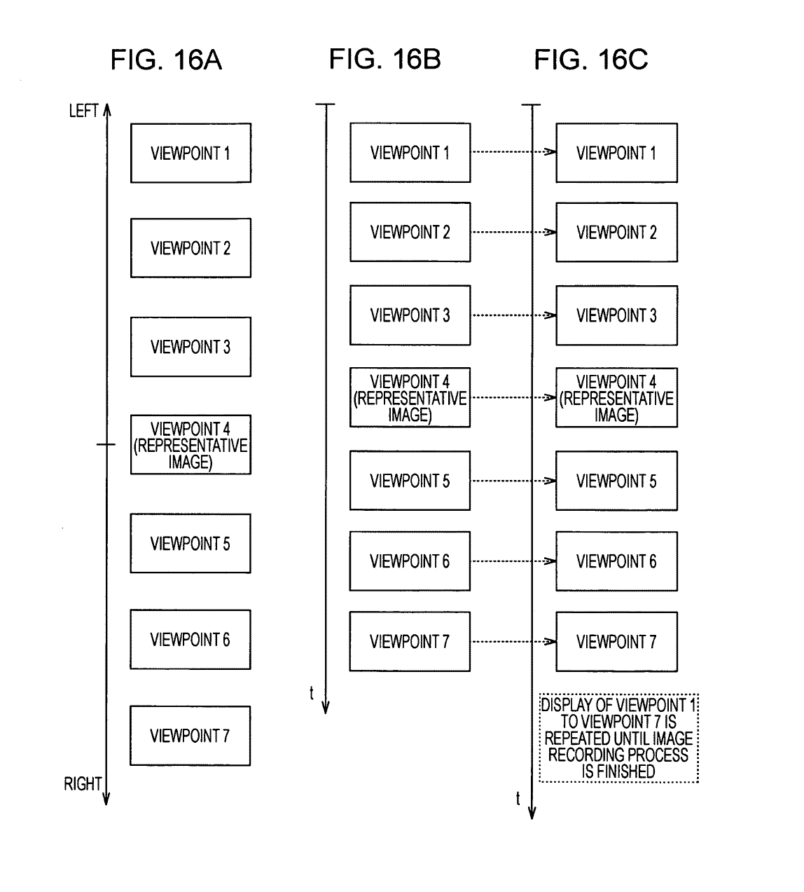

In FIGS. 15B and 16B, the multi-viewpoint images of viewpoints 1 to 7 generated by the synthesis process are arranged in the generation order thereof, after the imaging actions for generating the multi-viewpoint images of viewpoints 1 to 7 shown in FIG. 12A are finished. In this example, the example of performing the synthesis process of the multi-viewpoint images from the left viewpoint (viewpoint 1) to the right viewpoint (viewpoint 7) toward the subject in ascending order is shown.

FIG. 15C shows the display transition example of the multi-viewpoint images displayed on the display unit 285 during the synthesis process shown in FIG. 15B. That is, FIG. 15C shows an example of sequentially review displaying the multi-viewpoint images generated by the synthesis process in the generation order thereof after the imaging actions for generating the multi-viewpoint images are finished.

FIG. 16C shows the display transition example of the multi-viewpoint images displayed on the display unit 285 during the synthesis process shown in FIG. 16B. That is, FIG. 16C shows an example of sequentially review displaying the multi-viewpoint images in ascending order by viewpoint number and then sequentially review displaying the multi-viewpoint images in ascending order by viewpoint number, similar to the example shown in FIG. 15C. That is, in the example shown in FIG. 16C, a display operation for sequentially review displaying the multi-viewpoint images in ascending order by viewpoint number is repeatedly performed until the process of recording the generated multi-viewpoint images in the content storage unit 300 is finished. Although the example of sequentially review displaying the multi-viewpoint images in ascending order by viewpoint number in the example shown in FIGS. 15A and 16C, the multi-viewpoint images may be sequentially review-displayed in descending order by viewpoint number.

The synthesis process of the multi-viewpoint images in ascending order by viewpoint number may be performed and the multi-viewpoint images generated by this synthesis process may be sequentially review-displayed. Thus, it is possible to easily confirm the other multi-viewpoint images in ascending or descending order by viewpoint number of the multi-viewpoint images along with the representative image of the multi-viewpoint images. By performing review display in ascending or descending order by viewpoint number, it is possible to easily confirm the multi-viewpoint images according to reproduction order of multi-viewpoint images.

Although the review display is performed in ascending order or descending order by viewpoint number in FIGS. 15A to 16C, the representative image is preferably review-displayed when the synthesis process of the multi-viewpoint images is finished. That is, the lastly review-displayed image is preferably set to the representative image.

### Progress Situation Notification Example of Synthesis Process of Multi-viewpoint Image

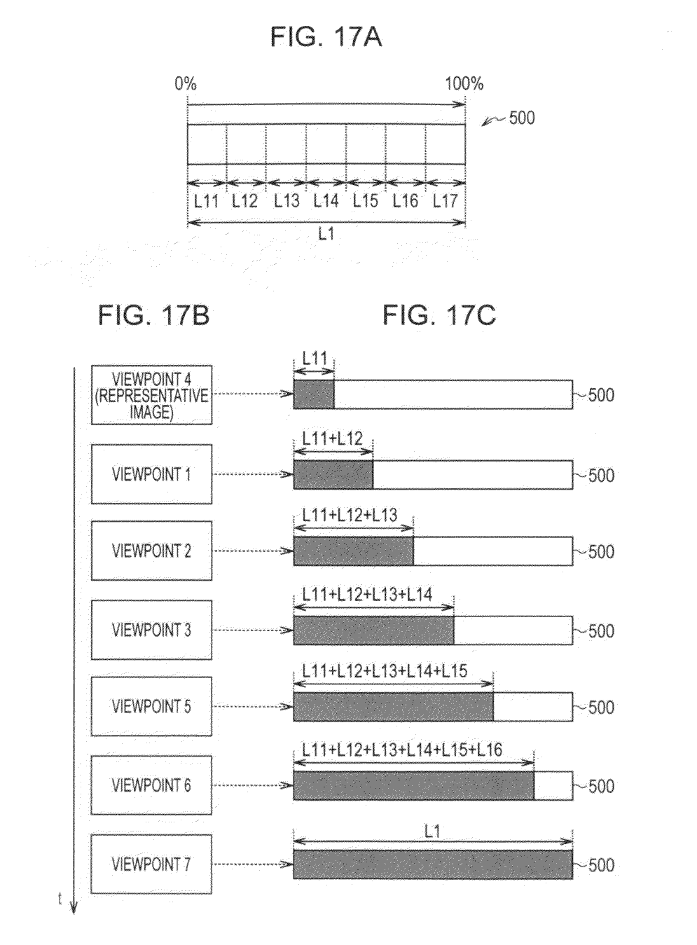

FIGS. 17A to 17C are diagrams schematically showing progress situation notification information of a synthesis process of the multi-viewpoint images displayed on the display unit 285 according to the first embodiment of the present invention. In FIGS. 17A to 17C, an example of displaying the progress bar as the progress situation notification information (progress information) of the synthesis process of the multi-viewpoint images is shown. This progress bar indicates to what extent the synthesis process of the multi-viewpoint images has progressed using a bar graph. In the example shown in FIGS. 17A to 17C, the example of generating a 7-viewpoint image as the multi-viewpoint image is shown.

FIG. 17A schematically shows a display method when the progress bar 500 is displayed. For example, while the synthesis process of the multi-viewpoint images is performed, a progress situation notification screen (for example, a progress situation notification screen 520 shown in FIGS. 19A to 19D) in which the progress bar 500 is provided is displayed on the display unit 285. The progress bar 500 has a horizontal length L1.

If the 7-viewpoint image is generated as the multi-viewpoint image, the display control unit 280 calculates a value obtained by dividing the horizontal length of the progress bar 500 by 7 and sets 7 rectangular regions in the progress bar 500 by the calculated value. That is, the length L11 (=L12 to L17) is calculated as the value obtained by dividing the horizontal length of the progress bar 500 by 7, and 7 rectangular regions corresponding to the lengths L11 to L17 are set. These rectangular regions become units for sequentially changing the display state when the synthesis process of one multi-viewpoint image is finished.

FIG. 17B shows transition of the synthesis process of the multi-viewpoint images. In FIG. 17B, a vertical axis is a time axis and the synthesized multi-viewpoint images are schematically arranged along the time axis. In FIG. 17C, the display transition of the progress bar 500 changed according to the synthesis process shown in FIG. 17B is shown. In the example shown in FIGS. 17B and 17C, the correspondence relationships are horizontally arranged according to the transition of the synthesis process of the multi-viewpoint images shown in FIG. 17B and the display transition of the progress bar 500 changed according to the synthesis process shown in FIG. 17C.

For example, the progress situation notification screen (for example, the progress situation notification screen 520 shown in FIGS. 19A to 19D) is displayed on the display unit 285 immediately after the imaging actions of the multi-viewpoint images are finished. The progress bar 500 is displayed by a single color (for example, white) immediately after the progress situation notification screen is displayed. Subsequently, the synthesis process of the multi-viewpoint images begins and, when the synthesis process of one multi-viewpoint image is finished, as shown in FIG. 17C, the display control unit 280 changes the display state of the rectangular region (the rectangular region corresponding to the length L11) of the left end (for example, changed to gray).

As shown in FIG. 17C, whenever the synthesis process of the multi-input image is finished, the display control unit 280 sequentially changes the display state of the rectangular regions (the rectangular regions corresponding to the lengths L12 to L16) from the left end by the number of synthesized multi-viewpoint images. If all the synthesis processes of the multi-viewpoint images are finished, the display state of each rectangular region (that is, the entire progress bar 500) is changed.

Whenever the synthesis process of the multi-viewpoint images is finished, the display state of the progress bar 500 is changed and the progress situation of the synthesis process of the multi-viewpoint image is indicated such that the user can easily identify the situation of the synthesis process.

In this example, the example of changing the display state of the progress bar 500 whenever the synthesis process of the multi-viewpoint images is finished is described. For example, if the number of multi-viewpoint images as an object to be synthesized is large, a plurality of multi-viewpoint images may be set as one unit and the display state of the progress bar 500 may be changed whenever the synthesis process of the multi-viewpoint images is finished. For example, if 5 multi-viewpoint images are set to one unit, the display state of the progress bar 500 is changed whenever the synthesis process of a fifth multi-viewpoint image is finished. Accordingly, it is possible to prevent the display state of the progress bar 500 from being frequently updated and enable the user to easily view the progress bar.

Display Example of Progress Situation Notification Screen of Synthesis Process of 2-viewpoint Images

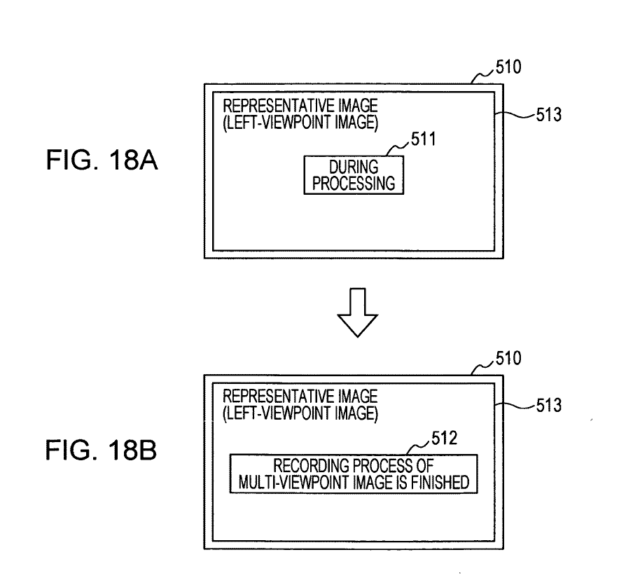

FIGS. 18A and 18B are diagrams showing a display transition example of a progress situation notification screen displayed on the display unit 285 according to the first embodiment of the present invention. In FIG. 18, an example of the progress situation notification screen in the case where 2-viewpoint images are recorded as the multi-viewpoint images is shown.

FIG. 18A shows a progress situation notification screen 510 displayed on the display unit 285 immediately after the imaging actions of 2-viewpoint images are finished. On the progress situation notification screen 510, a representative image (for example, a left-viewpoint image) 513 of the 2-viewpoint images is displayed and a during-processing message 511 is displayed so as to be superimposed on the representative image 513. In the representative image 513 shown in FIGS. 18A and 18B, the character of the representative image (left-viewpoint image) is attached to and briefly shown in a rectangle corresponding. Even in the display image shown in FIGS. 19A to 21D, similarly, the character indicating each image is attached to and schematically shown in a rectangle corresponding thereto.

The during-processing message 511 is a character indicating that the synthesis process of the 2-viewpoint images is being executed. In addition, on the progress situation notification screen 510, only the during-processing message 511 is displayed until the synthesis process of the representative image of the 2-viewpoint images is finished.

FIG. 18B shows the progress situation notification screen 510 displayed on the display unit 285 immediately after the recording process of the 2-viewpoint images is finished. On the progress situation notification screen 510, a representative image (for example, a left-viewpoint image) 513 of the 2-viewpoint images is displayed and a process end message 512 is displayed so as to be superimposed on the representative image 513. The process end message 512 is a character indicating the recording process of the 2-viewpoint images is finished.

If the recording process of the 2-viewpoint images is performed as described above, since the number of images to be synthesized is small, the synthesis process may be finished relatively quickly. To this end, on the progress situation notification screen displayed in the case where the recording process of the 2-viewpoint images is performed, the progress bar notifying the progress situation may not be displayed. In addition, the progress bar may be displayed according to the taste of the user.

Display Example of Progress Situation Notification Screen of Synthesis Process of Multi-viewpoint Images (3 viewpoints or more)

FIGS. 19A to 19D are diagrams showing a display transition example of a progress situation notification screen displayed on the display unit 285 according to the first embodiment of the present invention. In FIG. 19, an example of the progress situation notification screen in the case where 3 or more multi-viewpoint images is recorded is shown.

FIG. 19A shows a progress situation notification screen 520 displayed on the display unit 285 immediately after the imaging actions of multi-viewpoint images are finished. On the progress situation notification screen 520, a representative image 524 of the multi-viewpoint images is displayed and a progress bar 521 and a during-processing message 522 are displayed so as to be superimposed on the representative image 524. The progress bar 521 is equal to the progress bar 500 shown in FIGS. 17A to 17C. The during-processing message 522 is a character indicating that the synthesis process of the multi-viewpoint images is being executed. On the progress situation notification screen 520, only the progress bar 521 and the during-processing message 522 are displayed until the synthesis process of the representative image of the multi-viewpoint images is finished.

FIGS. 19B and 19C shows the progress situation notification screen 520 displayed on the display unit 285 while the synthesis process of the multi-viewpoint images is performed. On the progress situation notification screen 520, similar to FIG. 19A, the representative image 524, the progress bar 521 and the during-processing message 522 are displayed. The display state of the progress bar 521 is changed according to the number of synthesized multi-viewpoint images, as shown in FIG. 17C. FIG. 19C shows the progress situation notification screen 520 displayed on the display unit 285 immediately after the synthesis process of all the multi-viewpoint images is finished.

FIG. 19D shows the progress situation notification screen 520 displayed on the display unit 285 immediately after the recording process of the multi-viewpoint images is finished. On the progress situation notification screen 520, a representative image 524 of the multi-viewpoint images is displayed and a process end message 523 is displayed so as to be superimposed on the representative image 524. The process end message 523 is a character indicating the recording process of the multi-viewpoint images is finished.

In the above description, the example of displaying the representative image of the multi-viewpoint image and the progress bar while the synthesis process of the multi-viewpoint images is performed is described. As shown in FIGS. 13A to 16C, while the synthesis process of the multi-viewpoint images is performed, images other than the representative image of the multi-viewpoint images may be sequentially displayed. In addition to the progress bar, the progress situation notification information of the synthesis process of the multi-viewpoint images may be displayed by another display mode. Hereinafter, display examples thereof will be described.

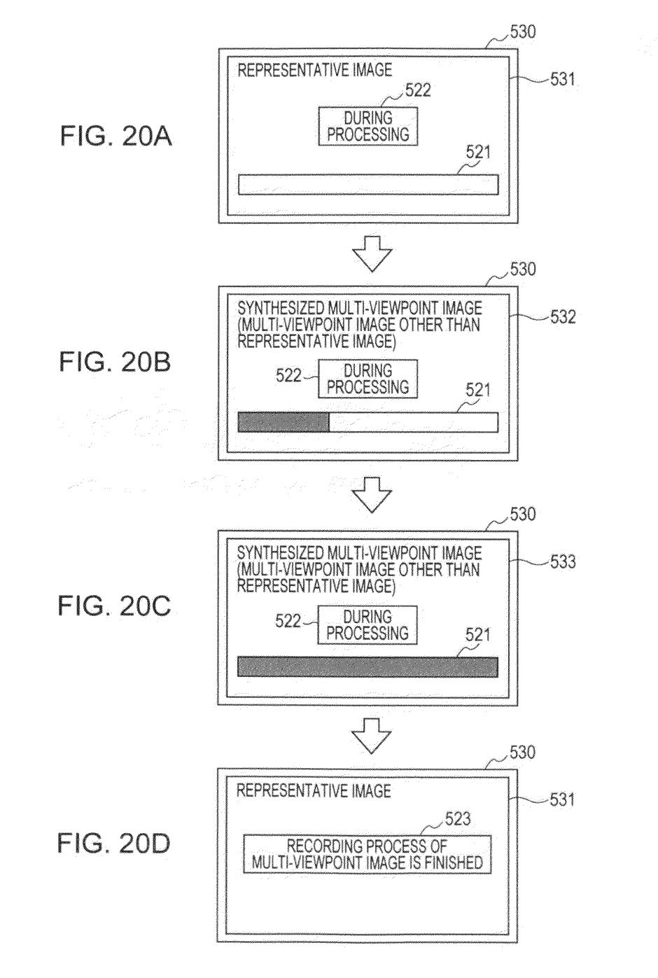

FIGS. 20A to 20D are diagrams showing a display transition example of a progress situation notification screen displayed on the display unit 285 according to the first embodiment of the present invention. FIGS. 20A to 20D show an example of the progress situation notification screen in the case where 3 or more multi-viewpoint images are recorded. The example shown in FIGS. 20A to 20D is a modified example of FIGS. 19A to 19D and the common parts with FIGS. 19A to 19D are denoted by the same reference numerals and the description thereof will be partially omitted.

FIG. 20A shows a progress situation notification screen 530 displayed on the display unit 285 immediately after the imaging actions of multi-viewpoint images are finished. On the progress situation notification screen 530, similar to FIG. 20A, a representative image 531, a progress bar 521 and a during-processing message 522 are displayed.

FIGS. 20B and 20C shows the progress situation notification screen 530 displayed on the display unit 285 while the synthesis process of the multi-viewpoint images is performed. On the progress situation notification screen 530, similar to FIGS. 19B and 19C, the progress bar 521 and the during-processing message 522 are displayed. However, FIGS. 20B and 20C are different from FIGS. 19B and 19C in that synthesized multi-viewpoint images 532 and 533 are displayed as a background. The synthesized multi-viewpoint images 532 and 533 are multi-viewpoint images other than the representative image of the multi-viewpoint images and may be displayed, for example, in order shown in FIG. 13 or 14.

FIG. 20D shows the progress situation notification screen 530 displayed on the display unit 285 immediately after the recording process of the multi-viewpoint images is finished. On the progress situation notification screen 520, similar to FIG. 19D, a representative image 531 and a process end message 523 are displayed. In this way, the representative image is preferably displayed immediately after the recording process of the multi-viewpoint images is finished.

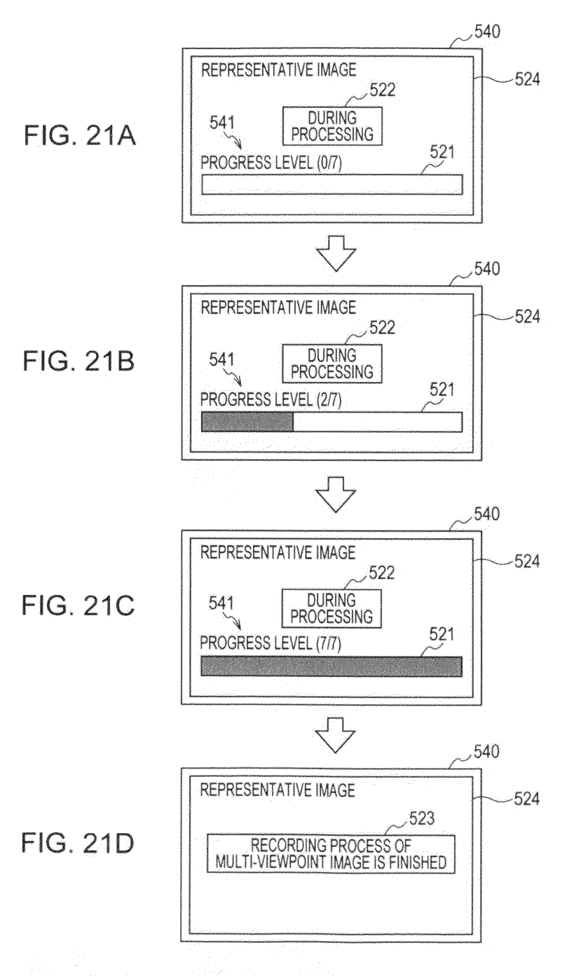

FIGS. 21A to 21D are diagrams showing a display transition example of a progress situation notification screen displayed on the display unit 285 according to the first embodiment of the present invention. FIGS. 21A to 21D show an example of the progress situation notification screen in the case where 3 or more multi-viewpoint images are recorded. The example shown in FIGS. 21A to 21D is a modified example of FIGS. 19A to 19D and the common parts with FIGS. 19A to 19D are denoted by the same reference numerals and the description thereof will be partially omitted.

FIG. 21A shows a progress situation notification screen 540 displayed on the display unit 285 immediately after the imaging actions of multi-viewpoint images are finished. On the progress situation notification screen 540, similar to FIG. 19A, a representative image 524, a progress bar 521 and a during-processing message 522 are displayed. However, FIG. 21A is different from FIG. 19A in that other progress situation notification information (progress situation notification information 541) is displayed so as to be superimposed on the representative image 524. The progress situation notification information 541 is information indicating the progress situation of the synthesis process of the multi-viewpoint images and indicates to what extent the synthesis process of the multi-viewpoint images has progressed using a numerical value. In the example shown in FIG. 21, the progress situation notification information 541 indicating the progress situation is expressed using a fraction in which the total number of multi-viewpoint images as an object to be synthesized is set as the denominator and the number of synthesized multi-viewpoint images is set as the numerator.

Since the progress situation notification screen 540 shown in FIG. 21A is displayed immediately after the imaging actions of the multi-viewpoint images are finished, the synthesis process of none of the multi-viewpoint images is finished. To this end, “progress level (0/7)” is displayed as the progress situation notification information 541.

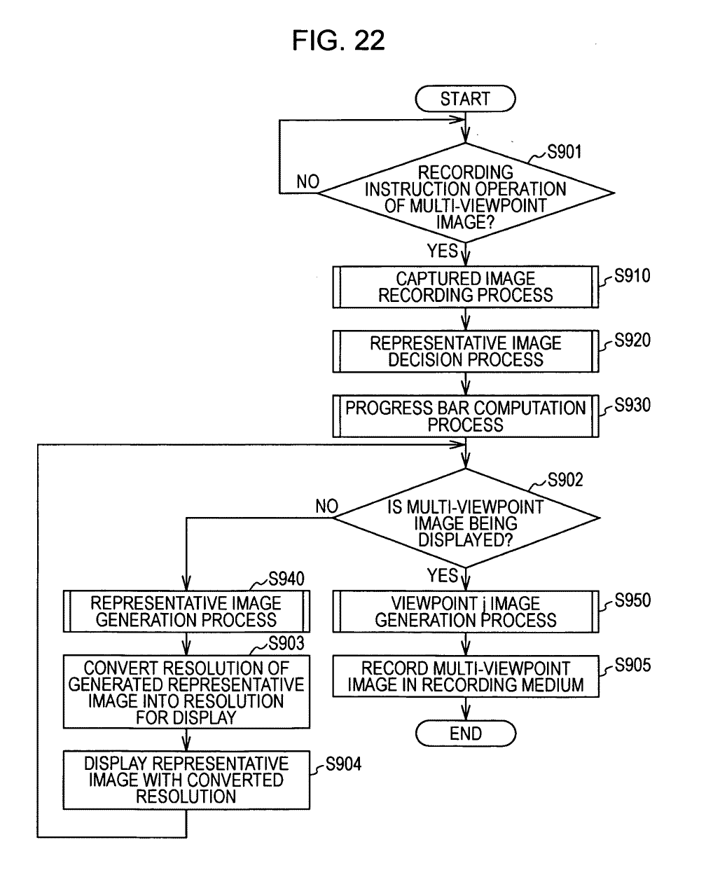

FIGS. 21B and 21C shows the progress situation notification screen 540 displayed on the display unit 285 while the synthesis process of the multi-viewpoint images is performed. On the progress situation notification screen 540, similar to FIGS. 19B and 19C, the progress bar 521 and the during-processing message 522 are displayed. However, FIGS. 22B and 22C are different from FIGS. 19B and 19C in that the progress situation notification information 541 is displayed. The progress bar 521 and the progress situation notification information 541 displayed while the synthesis process of the multi-viewpoint image is performed correspond to each other.

FIG. 21D shows the progress situation notification screen 540 displayed on the display unit 285 immediately after the recording process of the multi-viewpoint images is finished. On the progress situation notification screen 520, similar to FIG. 19D, a representative image 531 and a process end message 523 are displayed.

In this way, it is possible to more easily identify the progress situation by displaying the progress bar 521 and the progress situation notification information 541 while the synthesis process of the multi-viewpoint images is performed. Although the example of simultaneously displaying the progress bar 521 and the progress situation notification information 541 is described in this example, only the progress situation notification information 541 may be displayed. Other progress situation notification information (progress situation notification information of the synthesis process of the multi-viewpoint images) indicating to what extent the synthesis process of the multi-viewpoint images has progressed may be displayed. As the other progress situation notification information, for example, the ratio may be a numeral value (t) or a circular graph.

Although the example of setting the total number of multi-viewpoint images as the object to be synthesized as the denominator is described in FIG. 21, reducing may be performed and the progress situation notification information may be displayed by using the numerical value after thinning as the denominator, if the number of denominators is large. For example, if the denominator is 100, the denominator may be expressed as 10 by performing thinning. In this case, the value of the numerator is changed according to thinning.

### Action Example of Imaging Device

FIG. 22 is a flowchart illustrating an example of a procedure of a multi-viewpoint image recording process by the imaging device 100 according to the first embodiment of the present invention. In this procedure, an example of review displaying only a representative image will be described.

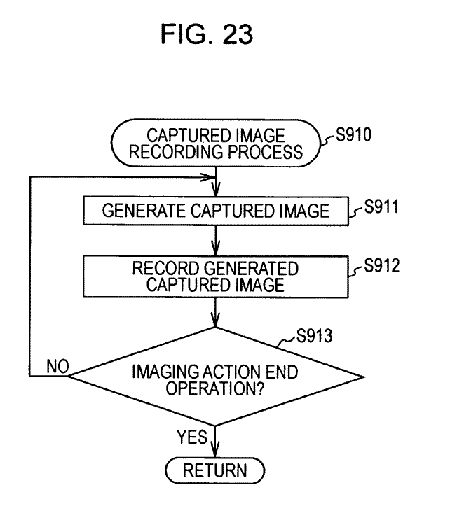

First, a determination as to whether or not a recording instruction operation of multi-viewpoint images is performed is made (step S901) and monitoring is continuously performed if the recording instruction operation is not performed. If the recording instruction operation is performed (step S901), a captured image recording process is performed (step S910). The captured image recording process will be described in detail with reference to FIG. 23. Step S910 is an example of an imaging step described in the claims.

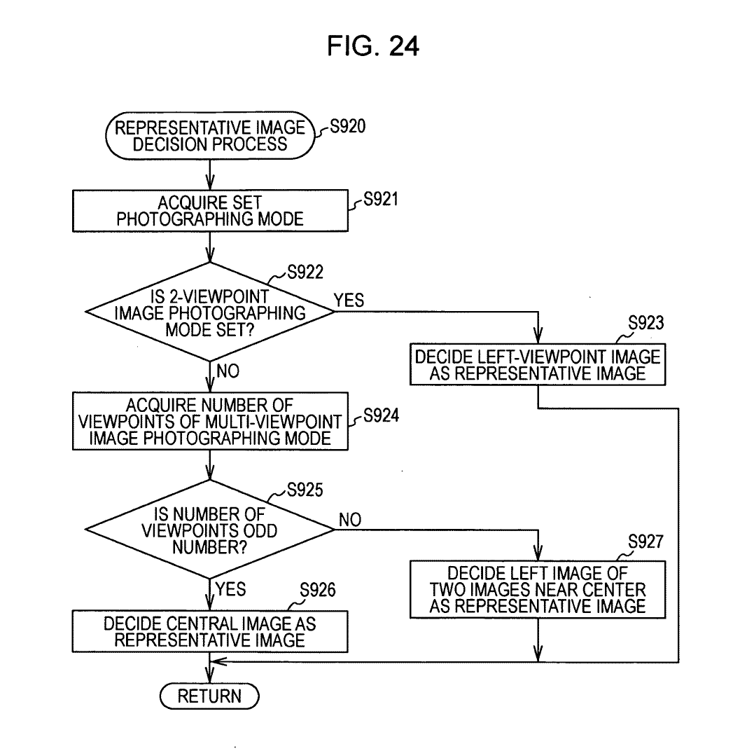

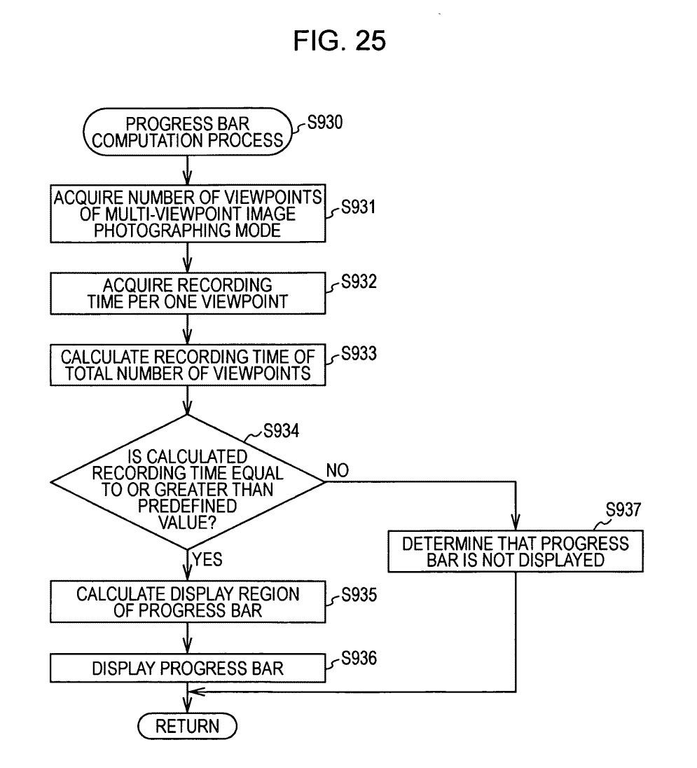

Subsequently, a representative image decision process is performed (step S920). The representative image decision process will be described in detail with reference to FIG. 24. Subsequently, a progress bar computation process is performed (step S930). The progress bar computation process will be described in detail with reference to FIG. 25.

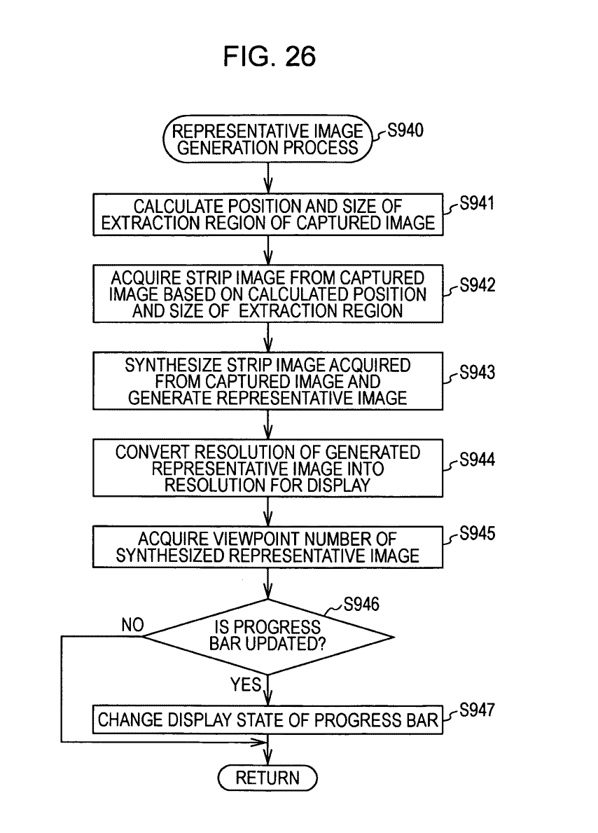

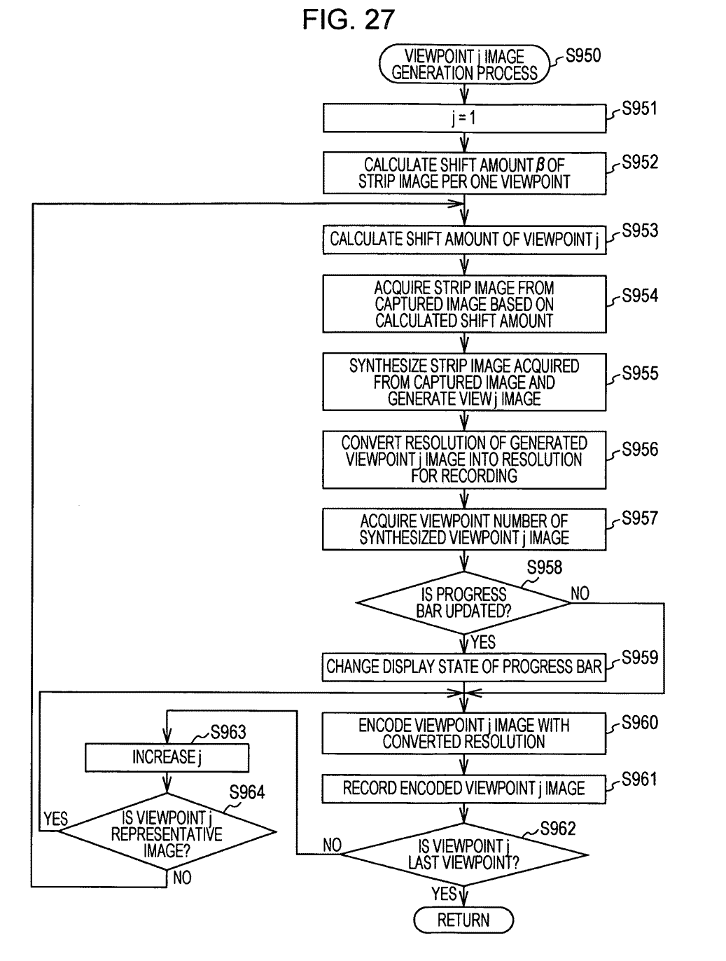

Subsequently, a determination as to whether or not the multi-viewpoint images are displayed on the display unit 285 is made (step S902) and, if the multi-viewpoint images are displayed on the display unit 285, a viewpoint j image generation process is performed (step S950). The view j image generation process will be described in detail with reference to FIG. 27. In contrast, if the multi-viewpoint images are not displayed on the display unit 285 (step S902), a representative image generation process is performed (step S940). The representative image generation process will be described in detail with reference to FIG. 26. Steps S940 and S950 are an example of a synthesis step described in the claims.

Subsequently, the display control unit 280 converts the resolution of the representative image generated by the synthesis unit 270 into a resolution for display (step S903) and displays the representative image for display with the converted resolution on the display unit 285(step S904).

After the viewpoint j image generation process (step S950), the recording control unit 290 records a plurality of multi-viewpoint images generated by the viewpoint j image generation process in the content storage unit 300 as an MP file (step S905).

FIG. 23 is a flowchart illustrating an example of the captured image recording process (the procedure of step S910 shown in FIG. 22) of the procedure of the multi-viewpoint image recording process by the imaging device 100 according to the first embodiment of the present invention.

First, the imaging unit 240 generates captured images (step S911) and sequentially records the generated captured images in the captured image holding unit 250 (step S912). Subsequently, a determination as to whether or not an imaging action end instruction operation is performed is made (step S913) and the action of the captured image recording process is finished if the imaging action end instruction operation is performed. If the imaging action end instruction operation is not performed (step S913), the process returns to step S911.

FIG. 24 is a flowchart illustrating an example of the representative image decision process (the procedure of step S920 shown in FIG. 22) of the procedure of the multi-viewpoint image recording process by the imaging device 100 according to the first embodiment of the present invention.

First, the photographing mode set by the user operation is acquired (step S921). A determination as to whether or not the 2-viewpoint image photographing mode is set is made (step S922) and the control unit 230 decides on the left-viewpoint image as the representative image if the 2-viewpoint image photographing mode is set (step S923).

In contrast, if the 2-viewpoint image photographing mode is not set (that is, a multi-viewpoint image photographing mode of 3 viewpoints or more is set) (step S922), the control unit 230 acquires the number of viewpoints of the set multi-viewpoint image photographing mode (step S924). Subsequently, a determination as to whether or not the acquired number of viewpoints is an odd number is made (step S925) and the control unit 230 decides on a central image as the representative image (step S926) if the acquired number of viewpoints is an odd number.

In contrast, if the acquired number of viewpoints is an even number (step S925), the control unit 230 decides on the left image of two images near the center as the representative image (step S927).

FIG. 25 is a flowchart illustrating an example of the progress bar computation process (the procedure of step S930 shown in FIG. 22) of the procedure of the multi-viewpoint image recording process by the imaging device 100 according to the first embodiment of the present invention.

First, the control unit 230 acquires the number of viewpoints of the set multi-viewpoint image photographing mode (step S931) and acquires the recording time per viewpoint (step S932). Subsequently, the control unit 230 calculates a recording time of the total number of viewpoints based on the acquired number of viewpoints and the recording time per one viewpoint (step S933).

Subsequently, a determination as to whether or not the calculated recording time of the total number of viewpoints is equal to or greater than a predefined value is made (step S934). If the calculated recording time of the total number of viewpoints is equal to or greater than the predefined value (step S934), the control unit 230 calculates a display region of a progress bar based on the acquired number of viewpoints (step S935). In this case, for example, if the number of multi-viewpoint images as an object to be synthesized is large, a plurality of multi-viewpoint images is set as one unit and the display state of the progress bar is set to be changed whenever the synthesis process of each multi-viewpoint image corresponding to each unit is finished. Subsequently, the display control unit 280 displays the progress bar on the display unit 285 (step S936). Step S936 is an example of a control step of claims.

If the calculated recording time of the total number of viewpoints is less than the predefined value (step S934), the control unit 230 decides that the progress bar is not displayed (step S937). In this case, the progress bar is not displayed on the display unit 285.

FIG. 26 is a flowchart illustrating an example of the representative image generation process (the procedure of step S940 shown in FIG. 22) of the procedure of the multi-viewpoint image recording process by the imaging device 100 according to the first embodiment of the present invention

First, the synthesis unit 270 calculates the positions and sizes of extraction regions (strip regions) of the captured images held in the captured image holding unit 250 based on the analyzed result output from the control unit 230 (step S941). Subsequently, the synthesis unit 270 acquires the strip images from the captured images held in the captured image holding unit 250 based on the calculated positions and sizes of the extraction regions (step S942).

Subsequently, the synthesis unit 270 synthesizes the strip images acquired from the captured images and generates the representative image (step S943). In this case, the synthesis unit 270 synthesizes the acquired images so as to be superimposed based on the movement amount and the movement direction output from the movement amount detection unit 260 and generates the representative image.

Subsequently, the synthesis unit 270 converts the resolution of the generated representative image into a resolution for recording (step S944) and acquires a viewpoint number of the synthesized representative image (step S945). Subsequently, a determination as to whether it is necessary to update the progress bar is made (step S946). For example, if the display state of the progress bar using a plurality of multi-viewpoint images as one unit is set to be changed, it is determined that it is not necessary to update the progress bar until the synthesis process of each multi-viewpoint image corresponding to each unit is finished. If it is necessary to update the progress bar (step S946), the display control unit 280 changes the display state of the progress bar (step S947) and finishes the action of the representative image generation process. If it is not necessary to update the progress bar (step S946), the action of the representative image generation process is finished.

FIG. 27 is a flowchart illustrating an example of the viewpoint j image generation process (the procedure of step S950 shown in FIG. 22) of the procedure of the multi-viewpoint image recording process by the imaging device 100 according to the first embodiment of the present invention.

First, j=1 (step S951). Subsequently, the synthesis unit 270 calculates the strip position shift amount β using the size of the extraction region (strip region) calculated in step S941 (step S952). Subsequently, the synthesis unit 270 calculates the shift amount (for example, MQj shown in Equation 5) of the viewpoint j using the calculated strip position shift amount β (step S953).

Subsequently, the synthesis unit 270 acquires the strip image from each captured image held in the captured image holding unit 250 based on the calculated shift amount of the viewpoint j and the position and size of the extraction region (step S954).

Subsequently, the synthesis unit 270 synthesizes the strip image acquired from each captured image and generates the viewpoint j image (multi-viewpoint image) (step S955). At this time, the synthesis unit 270 synthesizes the acquired image so as to be superimposed based on the movement amount and the movement direction output from the movement amount detection unit 260 so as to generate the viewpoint j image.

Subsequently, the synthesis unit 270 converts the resolution of the generated viewpoint j image into the resolution for recording (step S956) and acquires the viewpoint number of the synthesized viewpoint j image (step S957). Subsequently, a determination as to whether or not it is necessary to update the progress bar is made (step S958) and, if it is necessary to update the progress bar, the display control unit 280 changes the display state of the progress bar (step S959). In contrast, if it is not necessary to update the progress bar (step S958), the process proceeds to step S960.

Subsequently, the recording control unit 290 encodes the viewpoint j image with the converted resolution (step S960) and records the encoded viewpoint j image in the MP file (step S961). Subsequently, a determination as to whether or not the viewpoint j is the last viewpoint is made (step S962) and, if the viewpoint j is the last viewpoint, the action of the viewpoint j image generation process is performed. In contrast, if the viewpoint j is not the last viewpoint (step S962), j is increased (step S963) and a determination as to whether or not the viewpoint j image is a representative image is made (step S964). If the viewpoint j image is the representative image (step S964), the process returns to step S960 and, if the viewpoint j image is not the representative image, the process returns to step S953.

### 2. Second Embodiment

In the first embodiment of the present invention, the example of displaying the plurality of image generated by the series of imaging actions based on the predetermined rule is described. In the case of confirming the multi-viewpoint images generated by the imaging actions after the imaging actions of the multi-viewpoint images of the multi-viewpoint image photographing mode are finished, the user may wish to display a multi-viewpoint image of a specific viewpoint. Therefore, in the second embodiment of the present invention, an example of changing and displaying an image as an object to be displayed according to the attitude of the imaging device after the imaging actions of the multi-viewpoint images are finished will be described. The configuration of the imaging device of the second embodiment of the present invention is substantially equal to that of the examples shown in FIGS. 1 and 11 except that an input/output panel 710 is provided instead of the LCD 172. Accordingly, the parts in common with the first embodiment of the present invention are denoted by the same reference numerals and the description thereof will be partially omitted.

### Appearance Configuration of Imaging Device and Use Example Thereof

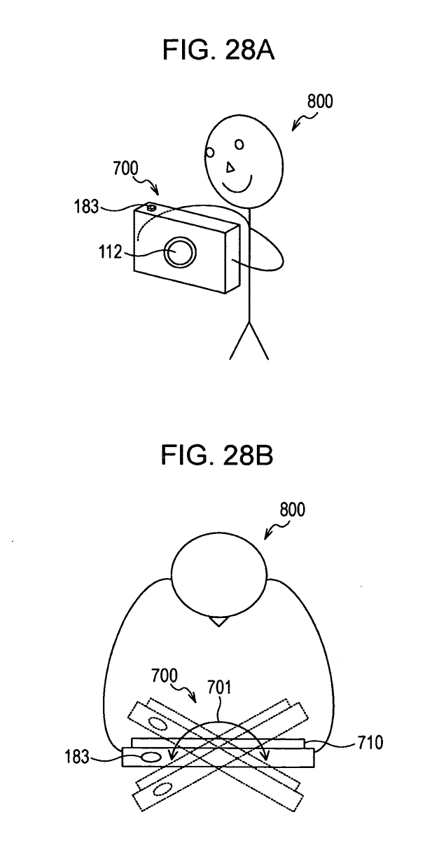

FIGS. 28A and 28B are diagrams showing an example of an appearance configuration example of an imaging device 700 according to a second embodiment of the present invention and an example of the attitude thereof when the imaging device is used. The imaging device 700 includes an input/output panel 710.

The input/output panel 710 displays various images and detects a touch action of the input/output panel 710 so as to receive an operation input from a user. That is, the input/output panel 710 includes a touch panel. The touch panel is, for example, provided so as to be superimposed on the display panel to transmit through the screen of the display panel and detects an object touching the display surface so as to receive an operation input from the user.

The imaging device 700 includes other operation members such as a power switch or a mode switch, a lens unit, or the like, which are not described and shown for ease of description. The optical unit 112 is partially mounted in the imaging device 700.

FIG. 28A shows an example of the attitude of the imaging device 700 in the case of performing review display of the multi-viewpoint images using the imaging device 700. For example, a person 800 can view an image display on the input/output panel 710 in a state of holding the imaging device 700 in both hands in the case of performing the display of the multi-viewpoint image using the imaging device 700 after the imaging actions of the multi-viewpoint images are finished.

FIG. 28B shows a transition example of the case of changing the attitude of the imaging device 700. FIG. 28B briefly shows an example of the case where the state shown in FIG. 28A is viewed from an upper surface.

Now, the change of the attitude of the imaging device 700 will be described. For example, in a state in which the user holds the imaging device 700 in both hands, the rotation angles (that is, the yaw angle, the pitch angle and the roll angle) around orthogonal 3 axes may be changed. For example, in the state of the imaging device 700 shown in FIG. 28B, the attitude of the imaging device 700 may be changed (the change of the yaw angle) in a direction denoted by an arrow 701 using the vertical direction as an axis. For example, in the state of the imaging device 700 shown in FIG. 28B, the attitude of the imaging device 700 may be changed (the change of the pitch angle) in a rotation direction using the horizontal direction as an axis. For example, in the state of the imaging device 700 shown in FIG. 28B, the attitude of the imaging device 700 may be changed (the change of the roll angle) in the rotation arrow direction using the front-and-rear direction of the person 800 as an axis.

In the second embodiment of the present invention, as shown in FIG. 28B, an example of sequentially changing the image review-displayed on the input/output panel 710 by changing the attitude of the imaging device 700 will be described. That is, an example of sequentially changing the image review-displayed by the input/output panel 710 by a gesture operation by a user will be described.

Association Example with Rotation Angle

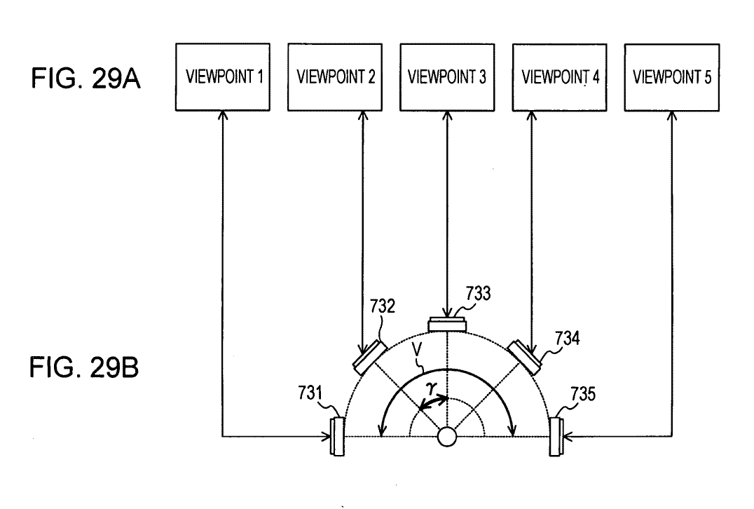

FIGS. 29A and 29B are schematic diagrams showing a relationship between a plurality of multi-viewpoint images generated using the imaging device 700 according to the second embodiment of the present invention and an inclination angle of the imaging device 700 when the images are review-displayed. In this example, the case of generating multi-viewpoint images of 5 viewpoints will be described.

FIG. 29A briefly shows the plurality of multi-viewpoint images (viewpoints 1 to viewpoint 5) generated using the imaging device 700.

FIG. 29B shows a transition example of the imaging device 700 in the case of review displaying the multi-viewpoint images after imaging actions of the plurality of multi-viewpoint images (viewpoint 1 to viewpoint 5) shown in FIG. 29A are finished. FIG. 29B shows the appearance of the bottom (that is, the surface opposed to the surface on which the shutter button 183 is provided) side of the imaging device 700.

FIG. 29B schematically shows an operation range (the entire range (angle V) of a rotation angle) of the imaging device 700 corresponding to transition of the imaging device 700. In addition, the angle V is preferably an angle at which the user may view the display screen and may be, for example, 180 degrees.

FIG. 29B shows an example of rotating the imaging device 700 in the direction denoted by the arrow 701 shown in FIG. 28B so as to change the attitude thereof and changing the display state of the multi-viewpoint images. In this case, the inclination angle (reference angle) which is a reference when the display state of the multi-viewpoint images is changed is set to γ. The inclination angle γ may be appropriately set according to the number of multi-viewpoint images or may be set by a user operation according to the taste of the user. The inclination angle γ may be set to, for example, 45 degrees.

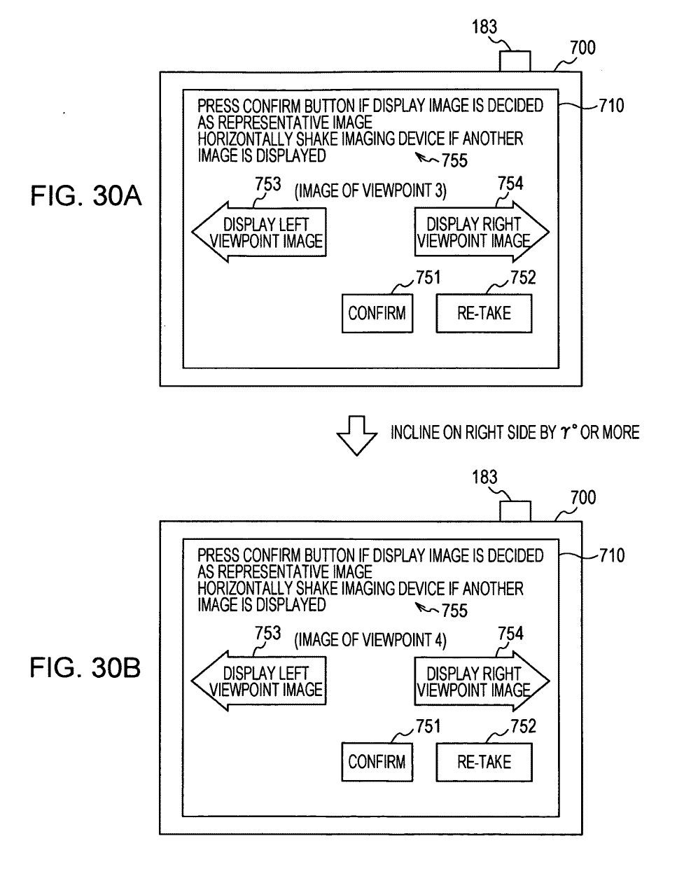

The multi-viewpoint images (viewpoints 1 to 5) shown in FIG. 29A and the imaging device 700 (the imaging device 700 of the states 731 to 735 inclined in units of inclination angle γ) shown in FIG. 29B are associated by arrows. The generated multi-viewpoint images (viewpoints 1 to 5) are appropriately assigned in states inclined in units of inclination angle γ. The operation for inclining the imaging device 700 so as to change the display change of the multi-viewpoint images will be described in detail with reference to FIG. 30.

FIGS. 30A and 30B are diagrams showing a display transition example of an image displayed on the input/output panel 710 according to the second embodiment of the present invention. FIG. 30A shows a display example of the input/output panel 710 immediately after the imaging actions of the multi-viewpoint images (viewpoints 1 to 5) shown in FIG. 29A are finished. For example, as described in the first embodiment of the present invention, immediately after the imaging actions of the multi-viewpoint images (viewpoints 1 to 5) are finished, a multi-viewpoint image of viewpoint 3 is displayed on the input/output panel 710 as representative images.

On the display screen shown in FIG. 30A, a multi-viewpoint image of viewpoint 3 is displayed and a confirm button 751, a re-take button 752, operation assisting information 753 and 754, and a message 755 are displayed to be superimposed on the multi-viewpoint images. The multi-viewpoint image displayed on the display screen shown in FIGS. 30A and 30B is briefly shown by attaching a character corresponding thereto in parentheses.

The confirm button 751 is pressed when the multi-viewpoint image (representative image candidate) displayed on the input/output panel 710 is newly decided on as the representative image. That is, if the confirm button 751 is pressed, the multi-viewpoint image displayed on the input/output panel 710 when the pressing operation is decided on as the new representative image. The recording control unit 290 associates the representative image information indicating the new representative image decided on and the order relationship (for example, viewpoint number) of the multi-viewpoint image with the generated multi-viewpoint images and records the multi-viewpoint images on the recording medium as an MP file.

The re-take button 752 is pressed, for example, when the imaging action of the multi-viewpoint image are performed again. That is, after the multi-viewpoint image displayed on the input/output panel 710 is confirmed, if the user determines that it is necessary to photograph the multi-viewpoint image again, it is possible to rapidly photograph the multi-viewpoint image again by pressing the re-take button 752.

The operation assisting information 753 and 754 is an operation guide to assist the operation for changing the multi-viewpoint image displayed on the input/output panel 710. The message 755 is an operation guide to assist the decision operation of the operation and the representative image.

FIG. 30B shows a display example of the input/output panel 710 in the case where the person 800 inclines the imaging device 700 from the state shown in FIG. 30A to the right side by γ degrees or more.

For example, as shown in FIG. 30A, in a state in which the multi-viewpoint image of viewpoint 3 is review-displayed on the input/output panel 710, the person 800 may wish to display another multi-viewpoint image. For example, if the person 800 inclines the imaging device 700 to the right side by γ degrees or more in a state in which the multi-viewpoint image of viewpoint 3 is review-displayed on the input/output panel 710, as shown in FIG. 30B, the multi-viewpoint image of viewpoint 4 is review-displayed on the input/output panel 710. For example, if the person 800 inclines the imaging device 700 to the right side by γ degrees or more in a state in which the multi-viewpoint image of viewpoint 4 is review-displayed on the input/output panel 710, the multi-viewpoint image of viewpoint 5 is review-displayed on the input/output panel 710.

In addition, for example, if the person 800 inclines the imaging device 700 to the left side by γ degrees or more in a state in which the multi-viewpoint image of viewpoint 3 is review-displayed on the input/output panel 710, the multi-viewpoint image of viewpoint 2 is review-displayed on the input/output panel 710. In addition, for example, if the person 800 inclines the imaging device 700 to the left side by γ degrees or more in a state in which the multi-viewpoint image of viewpoint 2 is review-displayed on the input/output panel 710, the multi-viewpoint image of viewpoint 1 is review-displayed on the input/output panel 710. In this way, the multi-viewpoint images other than the representative image may be review-displayed on the input/output panel 710 as the representative image candidate by the operation for inclining the imaging device 700.

If the confirm button 751 is pressed in a state in which the representative image candidate is review-displayed on the input/output panel 710 by the operation for inclining the imaging device 700, the representative image candidate is decided on as a new representative image. For example, if the confirm button 751 is pressed in a state in which the multi-viewpoint image of viewpoint 2 is review-displayed on the input/output panel 710 by the operation for inclining the imaging device 700, the multi-viewpoint image of viewpoint 2 is decided on as a new representative image, instead of the multi-viewpoint image of viewpoint 3.

For example, if the person 800 inclines the imaging device 700 in any one direction by γ degrees or more in a state in which the multi-viewpoint image of viewpoint 3 is review-displayed on the input/output panel 710, another multi-viewpoint image is review-displayed. In this case, the synthesis unit 270 may not finish the synthesis process of the multi-viewpoint image as an object to be displayed. Therefore, in the case where an image as an object to be displayed is changed by the operation for inclining the imaging device 700, if the synthesis process of the multi-viewpoint image as the object to be displayed is not finished, the synthesis process of the multi-viewpoint image as the object to be displayed is preferentially performed rather than the other multi-viewpoint images. That is, in the case where the change of the image as the object to be displayed by the operation for inclining the imaging device 700 is not performed, the synthesis process is sequentially performed in the same order as the first embodiment of the present invention. In contrast, in the case where the image as the object to be displayed is changed by the operation for inclining the imaging device 700 and the synthesis process of the multi-viewpoint image as the object to be displayed is not finished, the synthesis unit 270 preferentially performs the synthesis process of the multi-viewpoint image as the object to be displayed.

Accordingly, it is possible to easily and rapidly review display the multi-viewpoint image desired by the user according to the inclination of the imaging device 700. To this end, in the case where the user confirms the multi-viewpoint image, it is possible to easily perform confirmation. By the pressing of the confirm button 751, it is possible to decide on a desired multi-viewpoint image as the representative image.

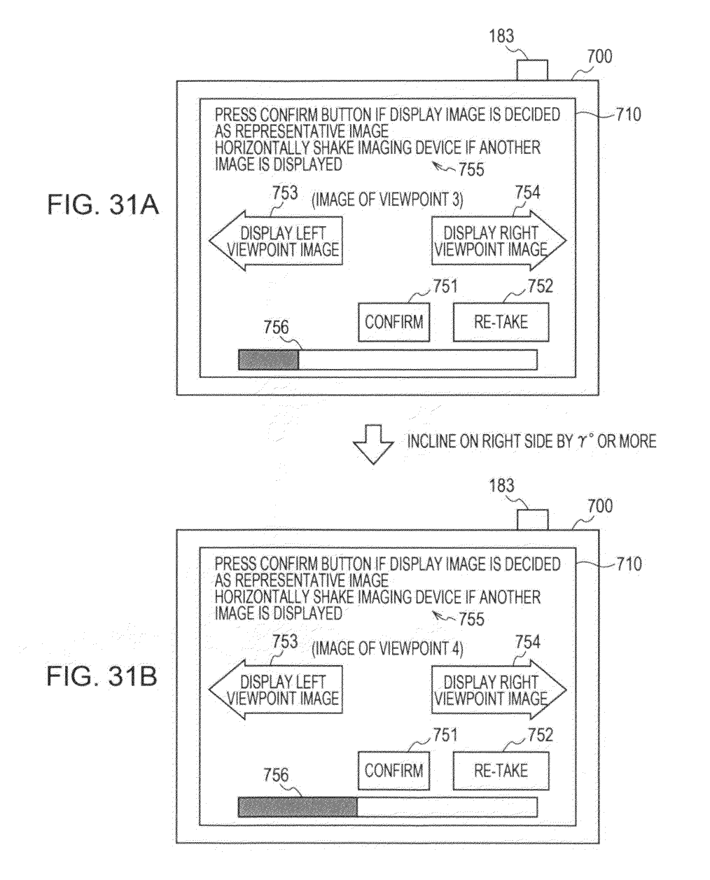

Although, in the example shown in FIGS. 30A and 30B, the display example in which the progress bar is omitted is shown, the progress bar may be displayed along with the multi-viewpoint image. An example of displaying the progress bar along with the multi-viewpoint image is shown in FIGS. 31A and 31B.

FIGS. 31A and 31B are diagrams showing a display transition example of an image displayed on the input/output panel 710 according to the second embodiment of the present invention. FIGS. 31A and 31B show an example in which a progress bar 756 is provided on each of the display screens shown in FIGS. 30A and 30B, and are is the same as the example shown in FIGS. 30A and 30B, except that another progress bar 756 is provided. The change or the like of the display state of the progress bar 756 is the same as that of the display state of the first embodiment of the present invention.

That is, the attitude detection unit 220 detects the change in attitude of the imaging device 700 based on the attitude of the imaging device 700 when the representative image is displayed on the input/output panel 710 as a reference. The control unit 230 performs control for sequentially displaying the multi-viewpoint image (representative image candidate) on the input/output panel 710 based on the detected change in attitude and the predetermined rule, after the representative image is displayed on the input/output panel 710. The predetermined rule, for example, indicates association between the multi-viewpoint images (viewpoints 1 to 5) shown in FIG. 29A and the states 731 to 735 shown in FIG. 29B (states 731 to 735 inclined in units of inclination angle γ).

Although, in the second embodiment of the present invention, the example of initially displaying the representative image on the input/output panel 710 is described, an initially displayed multi-viewpoint image may be decided on based on the change in attitude immediately after the process of generating the plurality of captured images by the imaging unit 240 is finished. That is, the attitude detection unit 220 detects the change in attitude of the imaging device 700 based on the attitude of the imaging device 700 immediately after the process of generating the plurality of captured images by the imaging unit 240 is finished as a reference. The control unit 230 may display the multi-viewpoint image corresponding to the order (viewpoint) according to the detected change in attitude on the input/output panel 710 as the initially displayed representative image. In this case, if the synthesis process of the multi-viewpoint image as the object to be displayed is not finished, the synthesis unit 270 preferentially performs the synthesis process of the multi-viewpoint image as the object to be displayed.

Although, in the second embodiment of the present invention, an example of using an operation method for inclining the imaging device 700 as an operation method for displaying a representative image candidate is described, the representative image candidate may be displayed using an operation member such as a key button.

In the second embodiment of the present invention, the example of displaying the representative image candidate by the user operation and deciding on the representative image is described. As described in the first embodiment of the present invention, if the multi-viewpoint images are automatically and sequentially displayed, the representative image may be decided on from the displayed multi-viewpoint images by the user operation. In this case, for example, if a desired multi-viewpoint image is displayed, the representative image may be decided on by a decision operation, using an operation member such as a confirm button.

### Operation Example of Imaging Device

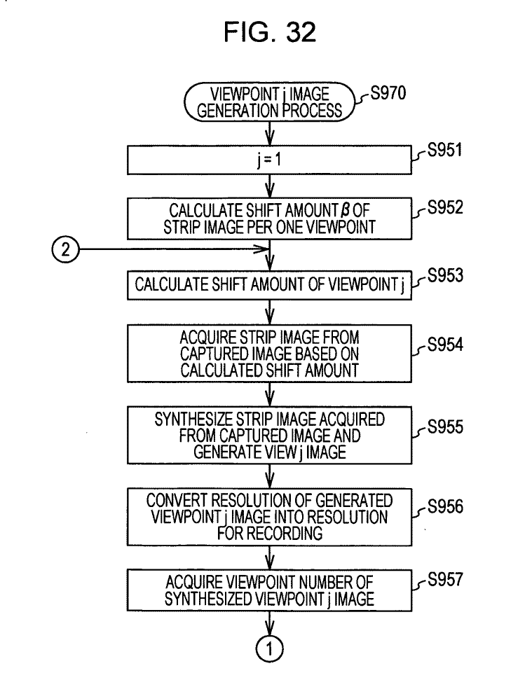

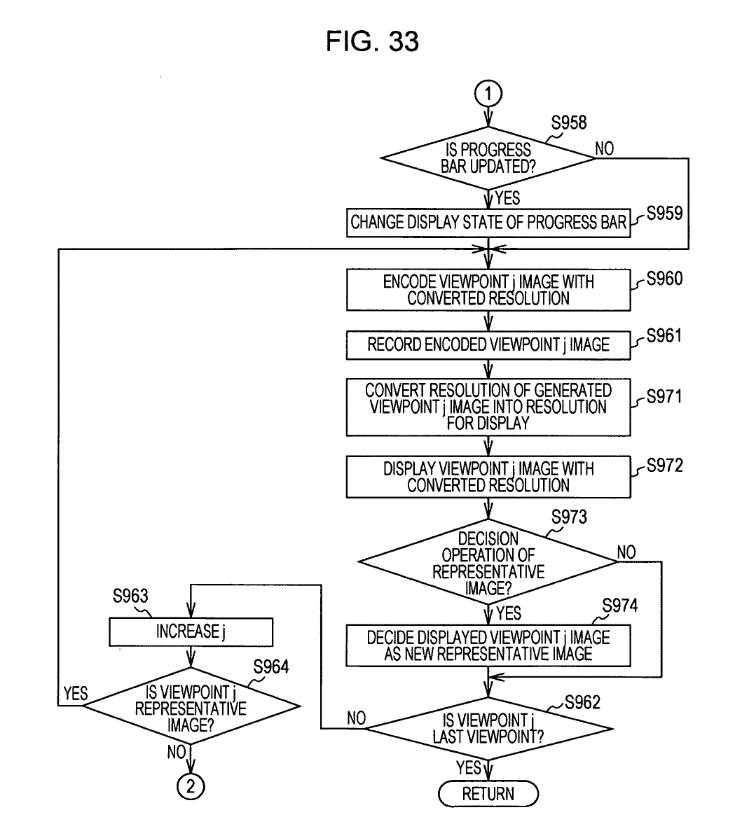

FIGS. 32 and 33 are flowcharts illustrating an example of a procedure of the multi-viewpoint image recording process by the imaging device 700 according to the second embodiment of the present invention. The procedure is a modified example of FIG. 27 (the procedure of step S950 shown in FIG. 22). To this end, the same parts as the procedure shown in FIG. 27 are denoted by the same reference numerals and the description of the common parts will be omitted. In this procedure, an example of deciding on the representative image by the user operation from the automatically and sequentially displayed multi-viewpoint images is described.

After the encoded viewpoint j image is recorded in the MP file (step S961), the display control unit 280 converts the resolution of the viewpoint j image generated by the synthesis unit 270 into the resolution for displaying (step S971). Subsequently, the display control unit 280 displays the viewpoint j image for display with the converted resolution on the display unit 285 (step S972).

Subsequently, a determination as to whether or not a decision operation of the representative image is performed (step S973) and, if the decision operation of the representative image is performed, the control unit 230 decides the viewpoint j image displayed on the display unit 285 as a new representative image (step S974). In contrast, if the decision operation of the representative image is not performed (step S973), the process proceeds to step S962.

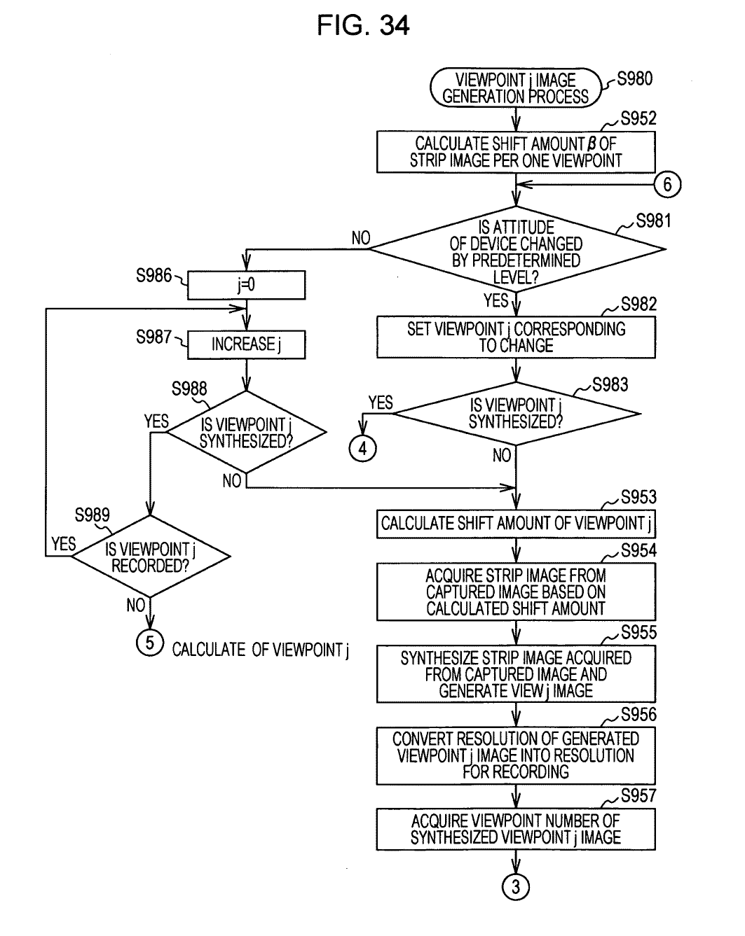

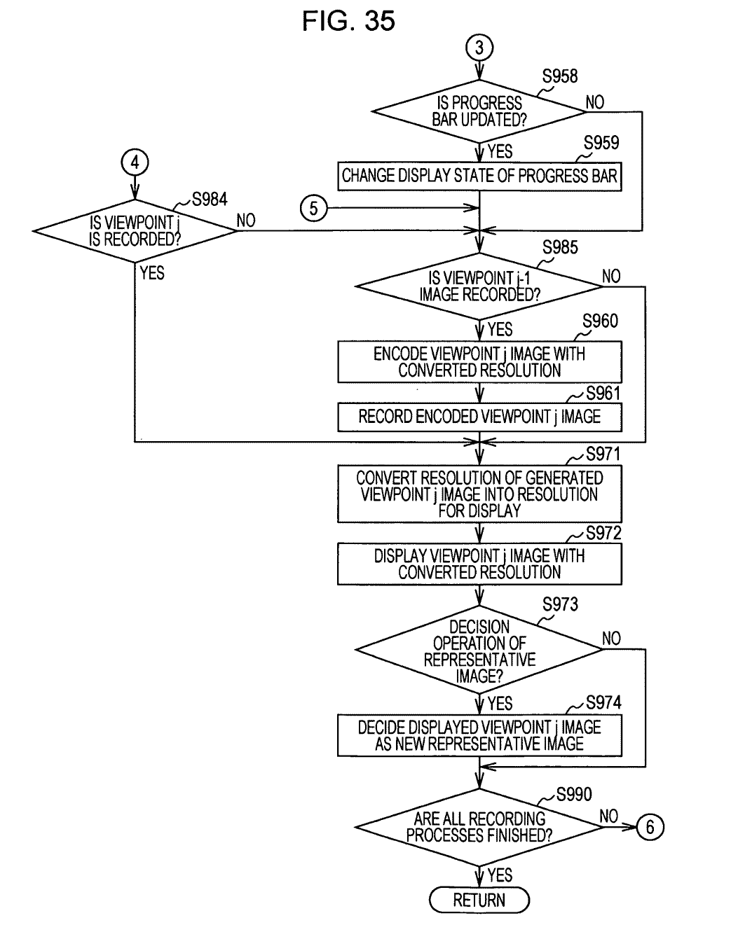

FIGS. 34 and 35 are flowcharts illustrating an example of a procedure of a multi-viewpoint image recording process by the imaging device 700 according to the second embodiment of the present invention. The procedure is a modified example of FIGS. 32 and 33 (the procedure of step S950 shown in FIG. 22). To this end, the same parts as the procedure shown in FIGS. 32 and 33 are denoted by the same reference numerals and the description of the common parts will be omitted. In this procedure, an example of displaying the representative image candidate by the user operation and decided on the representative image is described.

After the strip position shift amount β is calculated (step S952), a determination as to whether or not the attitude of the imaging device 700 is changed by a predetermined level or more is made (step S981) and, if the attitude of the imaging device 700 is not changed by the predetermined level or more, the process proceeds to step S985. In contrast, if the attitude of the imaging device 700 is changed by the predetermined level or more(step S981), the viewpoint j corresponding to the change is set (step S982). Subsequently, a determination as to whether or not the synthesis process of the multi-viewpoint image of viewpoint j is finished is made (step S983) and, if the synthesis process of the multi-viewpoint image of viewpoint j is finished, a determination as to whether or not the recording process of the multi-viewpoint image of viewpoint j is finished is made (step S984). Here, the case where the synthesis process of the multi-viewpoint image of viewpoint j is finished corresponds to, for example, the case where the conversion of resolution for recording is performed with respect to the viewpoint j image (multi-viewpoint image) generated by the synthesis of the strip image (for example, the viewpoint j image (final image) 420 shown in FIG. 9). In addition, the case where the recording process of the multi-viewpoint image of viewpoint j is finished corresponds to, for example, the case where the encoded viewpoint j image (multi-viewpoint image) is recorded in the MP file (for example, in the case of being recorded in the MP file shown in FIG. 9).

If the synthesis process of the multi-viewpoint image of viewpoint j is not finished (step S983), the process proceeds to step S953. If the recording process of the multi-viewpoint image of viewpoint j is finished (step S984), the process proceeds to step S971 and, if the recording process of the multi-viewpoint image of viewpoint j is not finished, the process proceeds to step S985.

In step S985, a determination as to whether or not the recording process of a viewpoint (j−1) image is finished is determined and, if the recording process of the viewpoint (j−1) image is finished, the process proceeds to step S960. In contrast, if the recording process of the viewpoint (j−1) image is not finished (step S985), the process proceeds to step S971.

If the attitude of the imaging device 700 is not changed by the predetermined level or more (step S981), j=0 (step S986) and j is increased (step S987). Subsequently, a determination as to whether or not the synthesis process of the multi-viewpoint image of viewpoint j is finished is determined (step S988) and, if the synthesis process of the multi-viewpoint image of viewpoint j is finished, a determination as to whether or not the recording process of the multi-viewpoint image of viewpoint j is finished is made (step S989). If the recording process of the multi-viewpoint image of viewpoint j is finished (step S989), the process returns to step S987 and, if the recording process of the multi-viewpoint image of viewpoint j is not finished, the process returns to step S985. If the synthesis process of the multi-viewpoint image of viewpoint j is not finished (step S988), the process returns to step S953.

If all the recording processes of the multi-viewpoint images are finished (step S990), the action of the viewpoint j image generation process is finished. In contrast, if all the recording processes of the multi-viewpoint images are not finished (step S990), the process returns to step S981.

In the embodiment of the present invention, the display example of the review display in the case of where the multi-viewpoint images are generated using the plurality of consecutive captured images in time series is described. In the case of generating the consecutive images using the plurality of consecutive captured images in time series, the embodiment of the present invention is applicable to the case of performing the review display with respect to the consecutive images. For example, if a consecutive mode is set, the imaging unit 240 generates the plurality (for example, 15) of consecutive captured images in time series. The recording control unit 290 assigns an order relationship based on a predetermined rule to at least a part (or all) of the plurality of generated captured images and records the captured image in the content storage unit 300 in association with each other. That is, the order relationship according to the generation order is assigned to the plurality of consecutive captured images in time series and the plurality of captured images are recorded as the image file of the consecutive image in association with each other. In this case, the control unit 230 performs control for displaying a captured image (for example, a central image (a seventh image)) which is arranged in the predetermined order of the plurality of captured images as an object to be recorded on the display unit 285 as the representative image, after the process of generating the plurality of captured images by the imaging unit 240 is finished.

The embodiments of the present invention are applicable to an imaging device of a mobile phone having an imaging function or a mobile terminal device having an imaging function.

In addition, the embodiments of the present invention are examples for realizing the present invention and, as described in the embodiments of the present invention, matters of the embodiments of the present invention respectively correspond to the specific matters of claims. Similarly, the specific matters of claims correspond to the matters of the embodiments of the present invention having the same names. The present invention is not limited to the embodiments and may be modified without departing from the scope of the present invention.

The procedures described in the embodiments of the present invention may be a method having a series of procedures or a program for executing, on a computer, the series of procedures or a recording medium for storing the program. As the recording medium, for example, a Compact Disc (CD), a Mini Disc (MD), a Digital Versatile Disc (DVD), a memory card, a Blu-ray Disc (registered trademark) or the like may be used.

The present application contains subject matter related to that disclosed in Japanese Priority Patent Application JP 2010-090118 filed in the Japan Patent Office on Apr. 9, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging device comprising:
an image unit that captures a subject and generates a plurality of consecutive captured images in time series;
a synthesis unit that performs synthesis using at least a part of each of the plurality of generated captured images and generates a plurality of synthesized images having an order relationship based on a predetermined rule; and
a control unit which performs control for displaying information about the progress of the generation of the synthesized images by the synthesis unit on a display unit as progress information, after the process of generating the plurality of captured images by the imaging unit is finished.

2. The imaging device according to claim 1, wherein the synthesis unit generates multi-viewpoint images as the plurality of synthesized images, and
wherein the control unit performs control for displaying a central image or an image near the central image of the multi-viewpoint images as a representative image on the display unit along with the progress information, immediately after the process of generating the plurality of captured images by the imaging unit is finished.

3. The imaging device according to claim 1, wherein the control unit performs control for displaying the progress information based on the number of synthesized images generated by the synthesis unit to the total number of the plurality of synthesized images as an object to be generated by the synthesis unit.

4. The imaging device according to claim 1, wherein the control unit performs control for displaying a progress bar indicating to what extent the synthesized images have been generated by the synthesis unit using a bar graph as the progress information.

5. The imaging device according to claim 1, wherein the control unit performs control for displaying the progress information on the display unit immediately after the process of generating the plurality of captured images by the imaging unit is finished.

6. The imaging device according to claim 1, wherein the control unit performs control for sequentially displaying at least a part of the generated synthesized images on the display unit along with the progress information.

7. The imaging device according to claim 6, wherein the control unit performs control for initially displaying a synthesized image which is arranged in the predetermined order of the generated synthesized images on the display unit as a representative image.

8. The imaging device according to claim 7, further comprising a recording control unit that associates representative image information indicating the representative image and the order relationship with the plurality of generated synthesized images and records the plurality of generated synthesized images on a recording medium.

9. The imaging device according to claim 8, wherein the recording control unit records the plurality of generated synthesized images associated with the representative image information and the order relationship on the recording medium as an MP file.

10. A display control method comprising the steps of:
capturing a subject and generating a plurality of consecutive captured images in time series;
performing synthesis using at least a part of each of the plurality of generated captured images and generating a plurality of synthesized images having an order relationship based on a predetermined rule; and
performing control for displaying information about progress of the generation of the synthesized images in the synthesis step on a display unit as progress information, after the process of generating the plurality of captured images in the imaging step is finished.

11. A program, on a computer, for executing a method comprising the steps of:
capturing a subject and generating a plurality of consecutive captured images in time series;
performing synthesis using at least a part of each of the plurality of generated captured images and generating a plurality of synthesized images having an order relationship based on a predetermined rule; and
performing control for displaying information about progress of the generation of the synthesized images in the synthesis step on a display unit as progress information, after the process of generating the plurality of captured images in the imaging step is finished.
